(19) United States
(12) Patent Application Publication
(10) Pub. No.: US 2013/0182630 A1
(43) Pub. Date: Jul. 18, 2013

(54) BASE STATION DEVICE

(71) Applicant: Takashi Yamamoto, Osaka-shi (JP)

(72) Inventor: Takashi Yamamoto, Osaka-shi (JP)

(73) Assignee: SUMITOMO ELECTRIC INDUSTRIES, LTD., Osaka-shi, Osaka (JP)

(21) Appl. No.: 13/822,854

(22) PCT Filed: Sep. 30, 2011
(86) PCT No.: PCT/JP2011/072525

§ 371 Date: Mar. 13, 2013

(30) Foreign Application Priority Data
Oct. 6, 2010 (JP) 2010-226888

(51) Int. Cl. H04W 72/04

(52) U.S. Cl. CPC H04W 72/0426
USPC 370/312; 370/336

(57) ABSTRACT

A base station device of the present invention includes: a downlink signal reception unit 12 that receives a downlink signal from another base station device; a synchronization processing unit 22 that acquires the downlink signal of the another base station device, and performs inter-base-station synchronization with the another base station device based on the downlink signal; and a setting unit 24 that sets an MBSFN subframe. The synchronization processing unit 22 acquires the downlink signal of the another base station device during the section of the MBSFN subframe set by the setting unit 24.

### TECHNICAL FIELD

The present invention relates to a base station device that performs wireless communication with terminal devices.

### BACKGROUND ART

A number of base station devices, each performing communication with terminal devices, are installed to cover a wide area. At this time, inter-base-station synchronization may be performed among a plurality of base station devices to achieve synchronization of radio frame timings or the like.

For example, Patent Literature 1 discloses inter-base-station synchronization performed by a base station device by using a transmission signal from another base station device that serves as a synchronization source.

### CITATION LIST

### Patent Literature

[PTL 1] Japanese Laid-Open Patent Publication No. 2009-177532

### SUMMARY OF THE INVENTION

### Problems to be Solved by the Invention

Patent Literature 1 discloses a case where communication between a base station device and a terminal device is performed in time division duplex (TDD). If a base station device that performs communication with a terminal device in frequency division duplex (FDD) is caused to perform inter-base-station synchronization, it is conceivable that the inter-base-station synchronization is performed in the following manner.

That is, as shown in FIG. 13, in a radio frame of a downlink signal according to the FDD scheme, a primary synchronization signal and a secondary synchronization signal, and a control signal are arranged in a constant cycle. The primary and secondary synchronization signals are used by a terminal device for the purposes of scanning base station devices, identifying a base station device, and the like. The control signal is used for transmitting control information required for radio communication with a terminal device. Among these signals, since the synchronization signals are known signals, it is conceivable that a base station device attempting to achieve inter-base-station synchronization with another base station device that will serve as a synchronization source is caused to utilize both the synchronization signals contained in a downlink signal transmitted by the another base station device, thereby achieving the inter-base-station synchronization.

For example, when a base station device adopting the FDD scheme attempts to achieve synchronization with another base station device, the base station device needs to receive and acquire a downlink signal transmitted by the another base station device, in order to acquire the synchronization signals. At this time, since the downlink signal from the another base station device and the downlink signal of the base station device use the same frequency band, the base station device cannot transmit its own downlink signal during a time period when it is receiving the downlink signal from the another base station device to acquire the same. Therefore, the base station device needs to suspend transmission of the own downlink signal at least during the time period when it acquires the synchronization signals contained in the downlink signal from the another base station device.

Further, in order to avoid mutual interference of downlink signals between the base station device and the another base station device, the base station device may comprehend the state of allocation of resources allocated by the another base station device to terminal devices connected to the another base station device, and perform, in accordance with the allocation state, resource allocation to terminal devices connected to the base station device.

Also in this case, the base station device needs to receive and acquire the downlink signal from the another base station device in order to comprehend the resource allocation state of the another base station device, and therefore, needs to suspend transmission of the own downlink signal during the time period when it acquires the downlink signal.

As described above, when a base station device suspends transmission of its own downlink signal to acquire a downlink signal from another base station device, in order to perform in inter-base-station synchronization with the another base station device or in order to comprehend the resource allocation state of the another base station device, since the downlink signal of the base station device contains a control signal that is needed to maintain communication connection with terminal devices connected to the base station device, the suspension of transmission influences communications of the terminal devices connected to the base station device.

This problem is likely to occur in a base station device adopting the TDD scheme in which a control signal is arranged at the beginning of each radio frame.

In view of the above, an object of the present invention is to provide a base station device that can acquire a downlink signal of another base station device while suppressing influence on communications of terminal devices.

### Solution to the Problems

(1) The present invention is a base station device comprising: a reception unit that receives a downlink signal of another base station device; an acquisition unit that acquires the downlink signal of the another base station device, which has been received by the reception unit; and a setting unit that sets, in a downlink signal of the base station device, a section in which it is not necessary to transmit, to a terminal device connected to the base station device, specific information required to maintain connection between the base station device and the terminal device. The acquisition unit acquires the downlink signal from the another base station device during the section set by the setting unit.

In the base station device of the above configuration, the acquisition unit acquires the downlink signal of the another base station device during the section in which it is not necessary to transmit the specific information required for connection between the base station device and the terminal device connected to the base station device. Therefore, even if transmission of the downlink signal of the base station device is suspended during the section, the terminal device connected to the base station device can maintain the connection without being influenced by the suspension of transmission of the specific information. As a result, it is possible to acquire the downlink signal of the another base station device while suppressing influence on communication of the terminal device.

(2) Since, as described above, the downlink signal of the another base station device can be acquired while suppressing influence on communication of the terminal device, the acquisition unit preferably performs inter-base-station synchronization with the another base station device, based on the acquired downlink signal of the another base station device.

In this case, it is possible to perform inter-base-station synchronization while suppressing influence on communication of the terminal device.

(3),(4) Further, in the above case, the acquisition unit preferably acquires, during the section, a known signal contained in the downlink signal of the another base station device, and performs the inter-base-station synchronization based on the known signal.

In this case, the base station device needs to suspend transmission of its own downlink signal and start reception of the downlink signal of the another base station device, at the beginning of the section, in order to acquire the known signal of the another base station device, and further needs to suspend the reception and start the transmission of its own downlink signal again at the end of the section. Thus, it is necessary to perform switching between the reception and the transmission before and after the reception of the known signal, within a relatively short time period.

On the other hand, the acquisition unit may adjust the positions, in the time axis direction, of the section and the downlink signal of the base station device so as to secure predetermined periods before and after the transmission timing of the known signal contained in the downlink signal of the another base station device, the periods being required for processing regarding acquisition of the downlink signal from the another base station device.

In this case, it is possible to secure, before and after the timing of reception of the known signal, a time margin for performing a process relating to acquisition of the downlink signal from the another base station device, such as switching between transmission and reception. Therefore, it is possible to reliably acquire the known signal even if switching between transmission and reception is performed before and after the reception of the known signal.

(5) Further, the acquisition unit preferably adjusts the positions, in the time axis direction, of the section and the downlink signal of the base station device so that the transmission timing of the known signal contained in the downlink signal of the another base station device is located substantially in the middle of the section. In this case, it is possible to appropriately secure the time margin for the processing relating to acquisition of the downlink signal, within the limited section.

(6) Further, the acquisition unit may perform measurement of the transmission state of the acquired downlink signal of the another base station device. Also in this case, it is possible to perform measurement of the transmission state of the downlink signal of the another base station device while suppressing influence on communication of the terminal device.

(7) The acquisition unit preferably notifies the setting unit of timing information indicating the timing to acquire the downlink signal of the another base station device, and the setting unit preferably sets, based on the timing information, the section at the period of time during which the acquisition unit acquires the downlink signal of the another base station device.

In this case, even if the acquisition unit acquires the downlink signal of the another base station device at an arbitrary timing, the setting unit can set the section at the period of time during which the acquisition unit acquires the downlink signal of the another base station device. As a result, it is possible to more reliably suppress influence on the terminal device at the time of acquisition of the downlink signal of the another base station device.

(8), (9), (10) Further, the specific information may be control information contained in each of subframes forming the downlink signal of the base station device. The section is preferably a section during which the base station device broadcasts predetermined information to the terminal device. More specifically, the section is preferably included in a subframe used for MBMS (Multimedia Broadcast Multicast Service).

In this case, the terminal device connected to the base station device can maintain the connection to the base station device, without receiving, during the section, the control information included in each of normal subframes different from the subframe used for the MBMS.

(11) Further, in the base station device, the setting unit previously notifies the terminal device of information indicating that the section has been set in the downlink signal of the base station device, and the notification is preferably performed such that, between the timing to notify the information indicating that the section has been set in the downlink signal of the base station device and the timing of the section, a time period is secured during which the terminal device can recognize that the section has been set.

In this case, the information indicating that the section is set in the downlink signal of the base station device can be previously notified to the terminal device to cause the terminal device to recognize the information. Therefore, even if the base station device suspends transmission during the section, it is possible to more reliably suppress influence on communication of the terminal device.

(12) Further, the base station device may further include a notification unit that notifies the another base station device that a subframe including the section is a blank section for suppressing interference due to the base station device.

The blank section is a section in which, for the purpose of interference suppression, signal transmission is not performed at all or substantial signal transmission is not performed, depending on a base station device in which the blank section is set, and a section in which use of the radio resource by the base station device is limited. Since, in the blank section, use of the radio resource by the base station device in which the blank section is set is limited, interference due to the base station device can be suppressed.

In the above case, regardless of whether the section is the blank section, the notification unit notifies the another base station device that the section is the blank section, and thereby the another base station device is caused to recognize that the section is the blank section. Thus, it is possible to cause the another base station device to understand that interference due to the base station device is suppressed during the section, and prompt the another base station to use the section. As a result, it is possible to achieve active utilization of communication resources between the base station devices.

On the other hand, the information indicating that the section is set in the downlink signal of the base station device is previously notified to the terminal device to cause the terminal device to recognize the information. Thereby, the terminal device is prevented from performing unnecessary scanning of neighboring base stations, and from recognizing that any abnormality occurs. Therefore, the notification unit is very useful.

(13) Further, when the setting unit suspends setting of the section in the downlink signal of the base station device, the notification unit may notify the another base station device that the subframe including the section to be suspended is not the blank section for suppressing interference due to the base station device, before use of the subframe including the section to be suspended is started.

In this case, since the notification unit notifies the another base station device that the subframe including the section to be suspended is not the blank section, before use of the subframe including the section to be suspended is started, it is possible to obviate interference that is likely to be caused by the base station device to another cell.

(14) A base station device of the present invention includes a setting unit that sets, in a downlink signal of the base station device, an acquisition section for acquiring a downlink signal of another base station device, and the setting unit sets the acquisition section, based on the timing of a blank section for suppressing interference due to the base station device, the blank section being set in the downlink signal of the base station device or the downlink signal of the another base station device.

The blank section is a section in which, for the purpose of interference suppression, use of the radio resource by the base station device is limited by reducing the transmission power with respect to some physical channels existing in the section, or by allocating only minimum data to some physical channels existing in the section, or by transmitting a minimum data signal or transmitting no data signal at all with respect to some physical channels existing in the section, or by reducing the amount of the radio resource to be used. Therefore, in the blank section, interference to a base station device other than the base station device in which the blank section is set in its downlink signal is suppressed, and therefore, it is possible to cause the base station device other than the base station device in which the blank section is set in its downlink signal to actively use the resource in the time zone corresponding to the blank section.

Therefore, according to the base station device of the above configuration, it is possible to achieve effective utilization of communication resources by appropriately setting the relationship between the timing of the acquisition section in which transmission of the downlink signal of the base station device needs to be suspended, and the timing of the blank section the use of which is limited.

(15) More specifically, when the blank section is set in the downlink signal of the base station device, if the acquisition section is set at a timing different from the timing of the blank section, the blank section the use of which is limited and the acquisition section in which transmission of the downlink signal of the base station device needs to be suspended, are arranged in parallel to each other in the downlink signal of the base station device, which might cause an increase in the number of sections the use of which is limited in the downlink signal.

Therefore, the setting unit preferably sets the acquisition section in the blank section set in the downlink signal of the base station device.

In this case, the section the use of which is limited can be substantially reduced by causing the acquisition section and the blank section, each being a section the use of which is limited, to overlap each other, thereby achieving effective utilization of communication resources.

(16) When the timing of the blank section set in the downlink signal of the another base station device and the timing of the acquisition section in the base station device overlap each other, there is a possibility that the base station device cannot acquire the downlink signal of the another base station device from the blank section the use of which is limited for interference suppression.

Therefore, the setting unit preferably sets the acquisition section at a timing different from the timing of the blank section set in the downlink signal of the another base station device. In this case, the base station device can reliably acquire the downlink signal of the another base station device, and the base station device can actively utilize the blank section set in the downlink signal of the another base station device.

(17) Further, the present invention is a base station device comprising: a setting unit that sets, in a downlink signal of the base station device, an acquisition section for acquiring a downlink signal of another base station device; and a notification unit that transmits, to the another base station device in which a blank section is set in its downlink signal, a notification that causes the another base station device to adjust the timing of the blank section, based on the timing of the acquisition section set by the setting unit, and on the timing of the blank section for suppressing interference due to the base station device, which is set in the downlink signal of the another base station device.

According to the base station device of the above configuration, the base station device includes the notification unit that transmits, to the another base station device in which a blank section is set in its downlink signal, a notification that causes the another base station device to adjust the timing of the blank section. Therefore, even if the base station device has a reason not to be able to move the acquisition sections set in its downlink signal, the base station device can cause the another base station device to adjust its blank section. Thereby, it is possible to appropriately set the relationship between the timing of the acquisition section in which transmission of the downlink signal of the base station device needs to be suspended, and the timing of the blank section the use of which is limited, and thus effective utilization of communication resources can be achieved.

(18) In the base station device, when the timing of the blank section of the another base station device and the timing of the acquisition section overlap each other, the notification unit preferably transmits, to the another base station device in which the blank section is set in its downlink signal, a notification that causes the another base station device to change the timing of the blank section.

In this case, the timing of the blank section set in the downlink signal of the another base station device and the timing of the acquisition section can be made different from each other, and therefore, the base station device can reliably acquire the downlink signal, and actively utilize the blank section set in the downlink signal of the another base station device.

(19) Further, when the another base station device that transmits the downlink signal to be acquired in the acquisition section is different from the another base station device in which the blank section is set in its downlink signal, the notification unit may transmit, to the another base station device in which the blank section is set in its downlink signal, a notification that causes the another base station device in which the blank section is set in its downlink signal to adjust the timing of the blank section, taking into consideration the reception intensity of the downlink signal of the another base station device that transmits the downlink signal to be acquired in the acquisition section.

(20) More specifically, if the reception intensity of the downlink signal acquired in the acquisition section is relatively low, it becomes difficult to acquire the downlink signal in the acquisition section due to interference of a downlink signal of a base station device other than the base station device that transmits the downlink signal acquired in the acquisition section. Therefore, even when the timing of the blank section and the timing of the acquisition section overlap each other, if the reception intensity is lower than a predetermined threshold, the notification unit preferably transmits, to the another base station device in which the blank section is set in its downlink signal, a notification that causes the another base station device to maintain the timing of the blank section.

In this case, if the timing of the acquisition section and the timing of the blank section are adjusted to be different from each other, there is a possibility that the downlink signal acquired in the acquisition section might be interfered because the reception intensity thereof is lower than the threshold. In this case, the notification unit transmits, to the another base station device in which the blank section is set in its downlink signal, a notification that causes the another base station device to maintain the timing of the blank section. Thereby, the downlink signal acquired in the acquisition section is prevented from being interfered, and the downlink signal can be reliably acquired in the acquisition section.

### Effects of the Invention

According to the base station device of the present invention, it is possible to acquire a downlink signal of another base station device while suppressing influence on communication of a terminal device.

### BRIEF DESCRIPTION OF THE DRAWINGS

FIG. 1 is a schematic diagram showing a configuration of a wireless communication system according to a first embodiment of the present invention in Chapter 1.

FIG. 2 is a diagram showing uplink and downlink communication frame structures for LTE.

FIG. 3 is a diagram showing a DL frame structure in detail.

FIG. 4 is a block diagram showing a configuration of a femto base station device.

FIG. 5 is a diagram showing the relationship between base station devices and a terminal device in MBMS.

FIG. 6 is a diagram for explaining an example of a manner of a synchronization process performed by a synchronization processing unit.

FIG. 7 is a diagram for explaining a manner of a synchronization process according to a second embodiment of the present invention in Chapter 1.

FIG. 8 is a diagram showing an inter-base-station network for connecting BSs 1 in a wireless communication system according to a third embodiment of the present invention in Chapter 1.

FIG. 9 is a block diagram showing a configuration of a femto base station device.

FIG. 10 is a diagram for explaining interference between cells.

FIG. 11 is a diagram showing the content of notification performed by a femto base station device to another base station device, and a terminal device connected to the femto base station device.

FIG. 12 is a diagram for explaining a manner of a synchronization process according to a third embodiment of the present invention in Chapter 1.

FIG. 13 is a diagram for explaining a manner of a synchronization process performed by a conventional base station device.

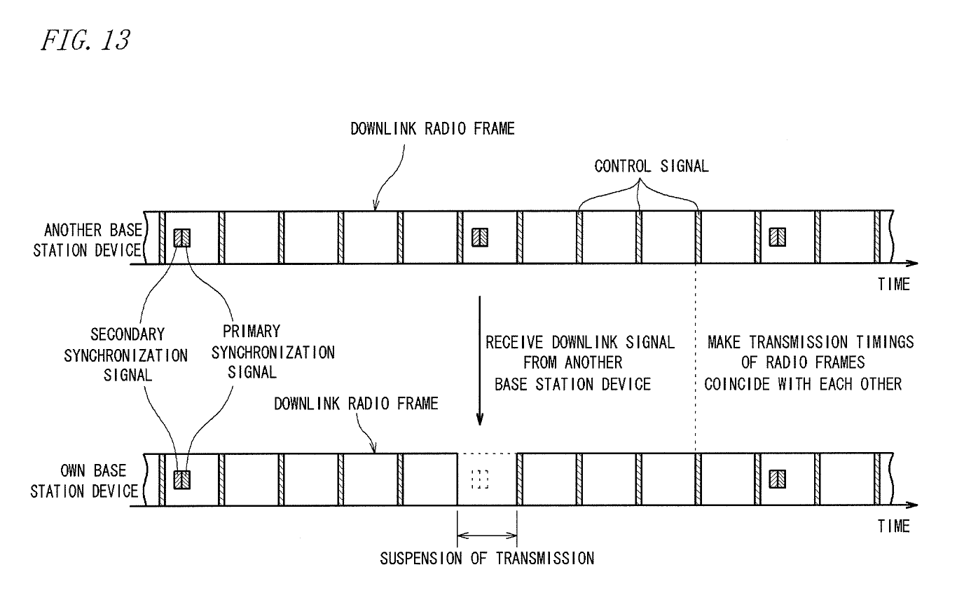

FIG. 14 is a schematic diagram showing a configuration of a wireless communication system in Chapter 2.

FIG. 15 is a diagram showing an inter-base-station network.

FIG. 16 is a diagram showing uplink and downlink radio frame structures for LTE.

FIG. 17 is a diagram showing a DL frame structure in detail.

FIG. 18 is a block diagram showing a configuration of a macro base station device.

FIG. 19 is a flowchart showing process steps of a synchronization process performed by a synchronization processing unit.

FIG. 20 is a diagram showing inter-cell-interference between a macro base station device and a pico base station device.

FIG. 21 is a diagram showing a manner of transmission/reception of information relating to an ABS pattern, which is performed by a base station device.

FIG. 22 is a diagram showing a part of a DL frame of a macro base station device according to a first embodiment, in association with a part of a DL frame of another base station device which is designated as a synchronization source by the macro base station device.

FIG. 23 is a diagram showing a part of a DL frame of a pico base station device according to a second embodiment, in association with a part of a DL frame of a macro base station device which is designated as a synchronization source by the pico base station device.

FIG. 24 is a diagram showing a part of a DL frame of a pico base station device according to a third embodiment, in association with a part of a DL frame of a base station device which is designated as a synchronization source by the pico base station device, and a part of a DL frame of a macro base station device which sets a macro cell to which the pico base station device belongs.

FIG. 25 is a flowchart showing process steps of a synchronization process performed by a synchronization processing unit of the pico base station device shown in FIG. 24.

FIG. 26 is a diagram showing a state where, in FIG. 24, setting of an ABS pattern of the macro base station device has been changed.

FIG. 27 is a diagram showing another example in FIG. 24.

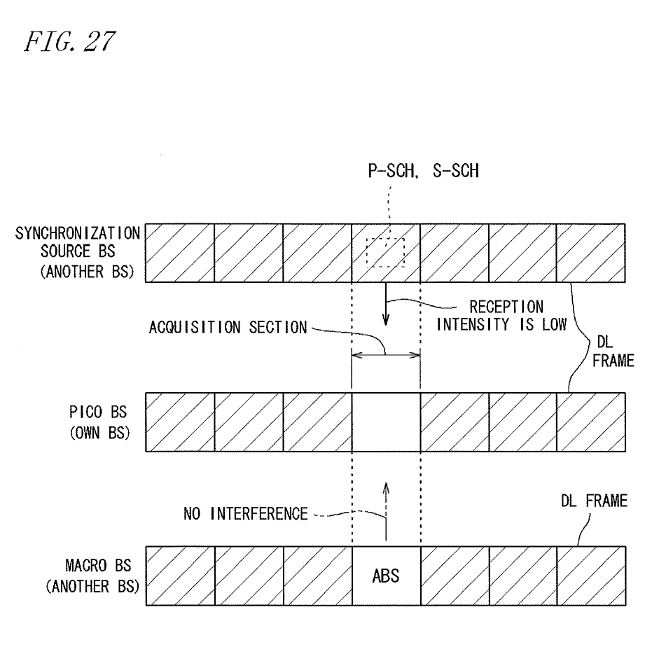

### DESCRIPTION OF EMBODIMENTS

### Chapter 1

Hereinafter, preferred embodiments of the present invention in Chapter 1 will be described with reference to accompanying drawings.

### 1. First Embodiment

### [1.1 Configuration of Communication System]

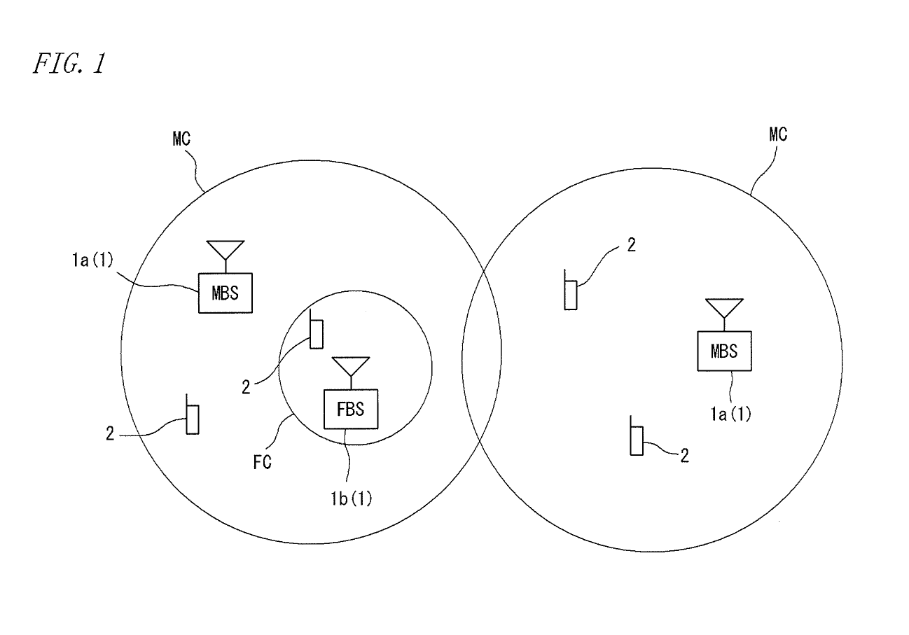

FIG. 1 is a schematic diagram showing a configuration of a wireless communication system according to a first embodiment of the present invention in Chapter 1.

The wireless communication system includes a plurality of base station devices 1, and a plurality of terminal devices (Mobile Stations) 2 that can perform wireless communication with the base station devices 1.

The plurality of base station devices 1 include a plurality of macro base station devices (Macro Base Stations) 1a each forming a communication area (macro cell) MC having a size of, for example, several kilometers, and a plurality of femto base station devices (Femto Base Stations) 1b installed in the macro cell MCs and each forming a relatively small femto cell FC having a size of several tens of meters.

Each macro base station device la (hereinafter also referred to as “macro BS 1a”) can perform wireless communication with a terminal device 2 that is present in a macro cell MC formed by the macro BS 1a.

On the other hand, each femto base station device 1b (hereinafter also referred to as “femto BS 1b”) is installed in a place where a radio signal from a macro BS 1a is difficult to be received, such as indoors, and forms a femto cell FC. The femto BS 1b can perform wireless communication with a terminal device 2 (hereinafter also referred to as “MS 2”) that is present in a femto cell FC formed by the femto BS 1b. In this system, the femto base station device 1b that forms a relatively small femto cell FC is installed in a place where a radio wave from a macro BS 1a is difficult to be received, thereby enabling provision of services with a sufficient throughput to the MS 2.

In the wireless communication system, after installation of a macro BS 1a, a femto BS 1b is installed in a macro cell MC formed by the macro BS 1a, and then the femto BS 1b forms a femto cell FC in the macro cell MC. Therefore, interference and the like may occur between the femto BS 1b and the macro BS 1a or an MS 2 or the like communicating with the macro BS 1a.

Therefore, the femto BS 1b has a function of monitoring (measurement) the transmission state, such as the transmission power and/or the operating frequency of a downlink signal in another base station device, such as the macro BS 1a or another femto BS 1b, and a function of adjusting, based on the result, the transmission condition such as the transmission power and/or the operating frequency, so as not to influence the communication in the macro cell MC. These functions allow the femto BS 1b to form a femto cell FC in the macro cell MC without influencing the communication performed by the another base station device.

In the communication system of the present embodiment, inter-base-station synchronization in which synchronization of timings of communication frames is achieved among a plurality of base station devices including the macro BS 1a and the femto BS 1b is performed.

The inter-base-station synchronization is performed by “over-the-air synchronization” in which synchronization is achieved such that a downlink signal transmitted from a base station device serving as a master station (synchronization source) to an MS 2 in its own cell is received by another base station device.

The base station device serving as a master station (synchronization source) may achieve over-the-air synchronization with still another base station device, or may determine frame timing by any other method than the over-the-air synchronization, e.g., autonomously determining frame timing using GPS signals.

Note that a macro BS 1a can have another macro BS 1a as a master station, but cannot have a femto BS 1b as a master station. A femto BS 1b can have a macro BS 1a as a master station or can have another femto BS 1b as a master station.

The wireless communication system of the present embodiment is, for example, a system for mobile phones to which LTE (Long Term Evolution) is applied, and communication based on the LTE is performed between each base station device and each terminal device. In the LTE, frequency division duplex (FDD) can be adopted. The present embodiment is described on assumption that the communication system adopts the FDD. However, the communication system is not limited to that based on the LTE. Further, the scheme adopted in the LTE is not limited to the FDD. For example, TDD (Time Division Duplex) may be adopted.

[1.2 Frame structure for LTE]

In the FDD scheme that can be adopted in the LTE on which the communication system of the present embodiment is based, uplink communication and downlink communication are simultaneously performed by allocating different operating frequencies to an uplink signal (a transmission signal from a terminal device to a base station device) and a downlink signal (a transmission signal from the base station device to the terminal device).

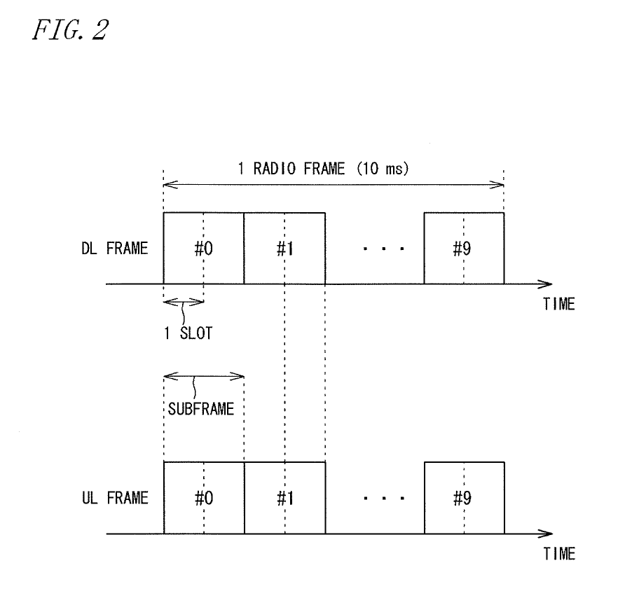

FIG. 2 is a diagram showing the structures of uplink and downlink radio frames for the LTE. Each of a downlink radio frame (DL frame) and an uplink radio frame (UL frame), which are the essential frames for the LTE, has a time length of 10 milliseconds per radio frame, and consists of 10 subframes #0 to #9 (each subframe is a communication unit area having a constant time length). The DL frame and the UL frame are arranged in the time-axis direction with their timings coinciding with each other.

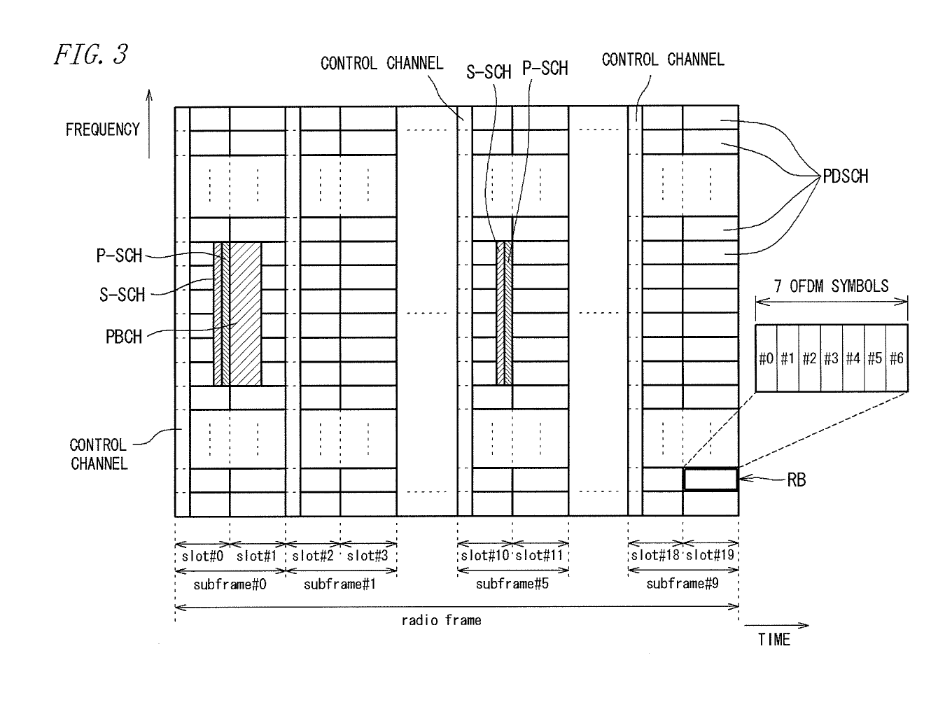

FIG. 3 is a diagram showing the structure of the DL frame in detail. In FIG. 3, the vertical axis direction indicates the frequency, and the horizontal axis direction indicates the time.

Each of subframes that form the DL frame consists of 2 slots. Each slot consists of 7 (#0 to #6) OFDM symbols (in the case of Normal Cyclic Prefix).

Further, in FIG. 3, a resource block (RB) that is a fundamental unit area for data transmission is defined by 12 subcarriers in the frequency-axis direction and 7 OFDM symbols (1 slot) in the time-axis direction.

Further, for the bandwidth of the DL frame in the frequency direction, a plurality of set values are provided up to the maximum of 20 MHz.

As shown in FIG. 3, at the beginning of each subframe, a transmission area for allocating, to a terminal device by a base station device, a control channel required for downlink communication is secured. This transmission area corresponds to symbols #0 to #2 (three symbols at maximum) in the front-side slot in each subframe. Allocated to the transmission area are: a physical downlink control channel (PDCCH) including, for example, allocation information of a physical downlink shared channel (PDSCH, described later) and a physical uplink shared channel (PUSCH, described later), in which user data are stored; a physical control format indicator channel (PCFICH) for notifying information relating to the PDCCH; and a physical hybrid-ARQ indicator channel for transmitting an acknowledgement (ACK) and a negative acknowledgement (NACK) in response to a hybrid automatic repeat request (HARQ) to the PUSCH.

In the DL frame, a physical broadcast channel (PBCH) is allocated to the first subframe #0. The PBCH notifies, by broadcasting, terminal devices of the frequency bandwidth and the like of the system. The PBCH is arranged, in the time-axis direction, in the position corresponding to symbols #0 to #3 in the rear-side slot in the first subframe #0 so as to have a width corresponding to 4 symbols, and arranged, in the frequency-axis direction, in the center of the bandwidth of the DL frame so as to have a width corresponding to 6 resource blocks (72 subcarriers). The PBCH is configured to be updated every 40 milliseconds by transmitting the same information over 4 frames.

The PBCH has, stored therein, major system information such as the communication bandwidth, the number of transmission antennae, and the structure of control information.

Further, the PBCH has, stored therein, information relating to the allocation position of a system information block (SIB) 1 that is stored in the PDSCH and to be transmitted and informed to an MS connected to the base station device, and a master information block (MIB) including a radio frame number required for demodulation of the corresponding PDSCH.

Further, among the 10 subframes that form the DL frame, the 1st (#0) and 6th (#5) subframes are each allocated a primary synchronization channel (P-SCH) and a secondary synchronization channel (S-SCH) which are signals for identifying a base station device or a cell.

The P-SCH is arranged, in the time-axis direction, in the position corresponding to symbol #6 that is the last OFDM symbol in the front-side slot in each of subframes #0 and #5 so as to have a width corresponding to one symbol, and arranged, in the frequency-axis direction, in the center of the bandwidth of the DL frame so as to have a width corresponding to 6 resource blocks (72 subcarriers).

The S-SCH is arranged, in the time-axis direction, in the position corresponding to symbol #5 that is the second last OFDM symbol in the front-side slot in each of subframes #0 and #5 so as to have a width corresponding to one symbol, and arranged, in the frequency-axis direction, in the center of the bandwidth of the DL frame so as to have a width corresponding to 6 resource blocks (72 subcarriers).

The P-SCH and the S-SCH are known signals that can take a plurality of patterns by being combined with each other. The pattern allows a terminal device to recognize which cell the terminal device belongs to.

As described above, each downlink signal is formed by arranging a plurality of subframes, and the plurality of subframes forming the downlink signal include subframes that include the P-SCH and the S-SCH, and subframes that do not include these signals.

The subframes (#0 and #5) that include the P-SCH and the S-SCH are arranged at intervals when the downlink signal is viewed in terms of units of subframes. By being arranged in the DL frame as described above, the P-SCH and the S-SCH are periodically arranged in the downlink signal, in a cycle corresponding to five subframes.

The P-SCH and the S-SCH periodically arranged as described above indicate the transmission timing of each of the subframes forming the radio frame. Therefore, the P-SCH and the S-SCH are used as signals not only for the case where a terminal device achieves synchronization with a base station device but also for inter-base-station synchronization in which synchronization of transmission timing and/or frequency (clock) of radio frames is achieved among base station devices.

Resource blocks in which the above-described channels are not allocated are used as physical downlink shared channels (PDSCH) in which user data and the like are stored. The PDSCH is an area shared by a plurality of terminal devices. In the PDSCH, control information and the like specific to each terminal device are stored in addition to the user data.

The above-mentioned SIB1 is an example of the control information stored in the PDSCH. The SIB1 is the control information to be transmitted to each terminal device connected to the base station device. For example, the SIB1 includes information relating to allocation of SIB2 to SIB9 each including information relating to the system. Further, the SIB1 includes information relating to MBSFN subframes described later.

Allocation of the user data stored in the PDSCH is notified to each terminal device by resource allocation information relating to downlink radio resource allocation, which is stored in the PDCCH allocated to the beginning of each subframe. The resource allocation information is information indicating radio resource allocation for each PDSCH, and allows each terminal device to know whether data directed to the terminal device is stored in the subframe.

The control information transmitted by the PDCCH, PCFICH, PBCH, and the like and the P-SCH and S-SCH are pieces of information (specific information) necessary for each terminal device connected to the base station device to maintain the connection. Therefore, the terminal device reads these pieces of information, and maintains wireless connection to the base station device, based on the information.

[1.3 Configuration of Base Station Device]

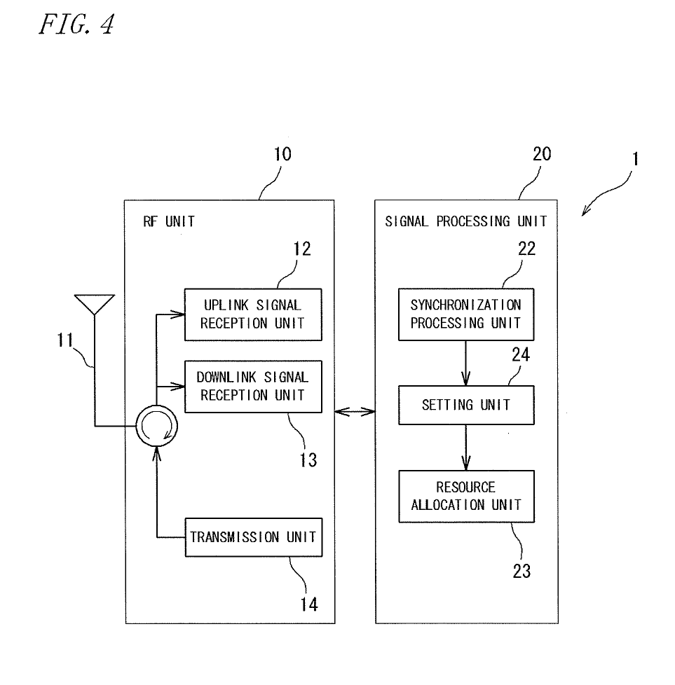

FIG. 4 is a block diagram showing the configuration of a femto BS 1b shown in FIG. 1. Although the configuration of a femto BS 1b will be described hereinafter, the configuration of a macro BS 1a is almost the same as that of the femto BS 1b.

The femto BS 1b includes an antenna 11, a transmission/reception unit (RF unit) 10 to which the antenna 11 is connected, and a signal processing unit 20 which performs processing regarding inter-base-station synchronization with another base station device, in addition to signal processing of transmission and reception signals between MSs 2, which signals are exchanged between the signal processing unit 20 and the RF unit 10.

The RF unit 10 includes an uplink signal reception unit 12, a downlink signal reception unit 13, and a transmission unit 14. The uplink signal reception unit 12 receives an uplink signal from an MS 2. The downlink signal reception unit 13 receives a downlink signal from another macro BS 1a or another femto BS 1b. The transmission unit 14 transmits a downlink signal to each MS 2.

The downlink signal received by the downlink signal reception unit 13 is provided to the signal processing unit 20, and processed by a synchronization processing unit 22 or a demodulation unit (not shown).

The signal processing unit 20 includes a synchronization processing unit 22, and a resource allocation unit 23.

The synchronization processing unit 22 has a function as an acquisition unit which acquires a downlink signal from another base station device 1, which is received by the downlink signal reception unit 13.

The synchronization processing unit 22 also has a function of performing a synchronization process in which the transmission timing of each subframe in the radio frame of the femto BS 1b is made to coincide with that of the another base station device 1 to achieve inter-base-station synchronization, based on a P-SCH and an S-SCH as known signals included in the downlink signal of the another base station device 1.

Inter-base-station synchronization may be performed by providing each of base station devices with a GPS receiver so that the base station devices can achieve synchronization by using GPS signals, or by connecting the base station devices via a cable. However, the present embodiment adopts inter-base-station synchronization based on “over-the-air synchronization” in which synchronization is achieved by using radio signals (downlink signals).

Specifically, the synchronization processing unit 22 determines to perform 1 the synchronization process when the femto BS 1b is activated, or periodically, or in response to an external instruction. Then, the synchronization processing unit 22 causes the transmission unit 14 to suspend transmission of the downlink signal of the femto BS 1b, and acquires the downlink signal of the another base station device 1 which has been received by the downlink signal reception unit 13.

The synchronization processing unit 22 detects the periodically arranged P-SCH and S-SCH which are included in the downlink signal of the another base station device 1 to obtain the transmission timing, frequency, and the like of the subframe in the radio frame in the another base station device 1.

Further, the synchronization processing unit 22 detects a synchronization error, based on the acquired transmission timing and frequency of the subframe in the downlink signal of the another base station device 1, and adjusts the subframe transmission timing and the subframe length of the femto BS 1b so as to coincide with those of the another base station device 1, thereby achieving synchronization.

Further, when determining to acquire the downlink signal of the another base station device 1 to perform the above-mentioned synchronization process, the synchronization processing unit 22 notifies a setting unit 24 (described later) of the acquisition timing to acquire the downlink signal of the another base station device 1 (timing to start the synchronization process).

The resource allocation unit 23 performs resource allocation to each MS 2 wirelessly connected to the femto BS 1b, with respect to the uplink and downlink subframes of the femto BS 1b. Further, the resource allocation unit 23 allocates various kinds of control information required for connection of each MS 2, to the downlink radio frame transmitted by the femto BS 1b. The resource allocation unit 23 also has a function of performing a process required to apply an MBSFN subframe (described later) to a predetermined subframe.

The signal processing unit 20 further includes a setting unit 24 that performs a setting process relating to MBMS (Multimedia Broadcast Multicast Service) for TV broadcast services and the like.

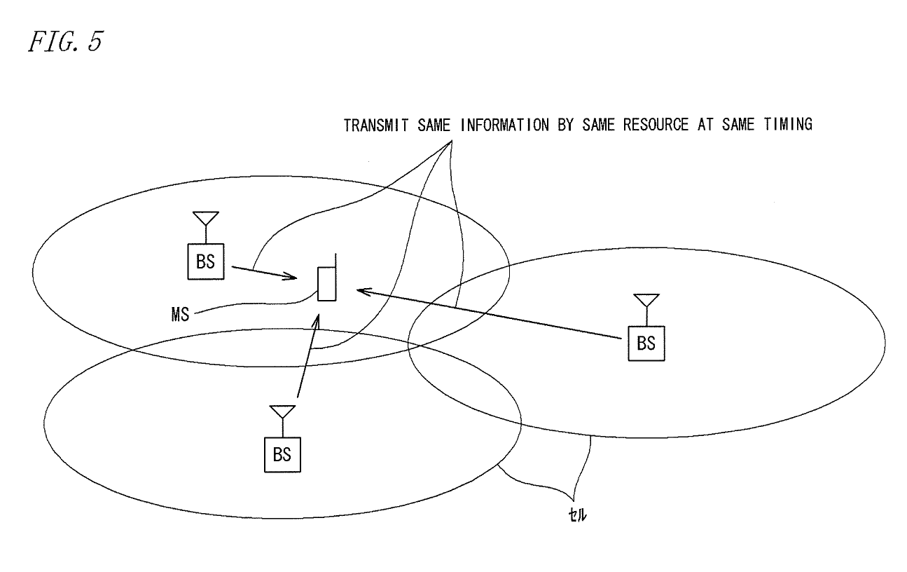

FIG. 5 is a diagram showing the relationship between base station devices and a terminal device in the case where information is provided by the MBMS. The MBMS is a service for transmitting, from a plurality of base station devices, the same information by using the same resource at the same timing. Accordingly, the terminal device can acquire the same information concurrently from the plurality of base station devices, as shown in FIG. 5.

When providing information by the MBMS, each base station device secures a subframe for the MBMS in a part of each radio frame. Using the subframe for the MBMS (MBSFN (MBMS Single Frequency Network) subframe), the base station device transmits the information relating to the MBMS to the terminal device.

Since the MBMS is a broadcast service, in the MBSFN subframe used for the MBMS, the information relating to the MBMS, and minimum necessary control information indicating that the corresponding subframe is an MBSFN subframe, are broadcast by using the control channel (two symbols at the beginning of the subframe), but control information directed to a specific terminal device is not transmitted.

Upon receiving information relating to the provision of the MBMS from the upper layer, each base station device, based on the information, includes, in the SIB1 of the downlink signal to be transmitted to the terminal device connected to the base station device, MBSFN subframe application information indicating the cycle and offset of the subframe to which the MBSFN subframe is applied (information relating to the timing of the MBSFN subframe in the radio frame). Then, each base station device applies the MBSFN subframe to the subframe specified by the application information.

The terminal device connected to each base station device reads the MBSFN subframe application information included in the SIB1 to recognize the timing of the subframe to which the MBSFN subframe is applied. The terminal device, in a normal subframe (a subframe including specific information such as control information) other than the MBSFN subframe, reads the specific information such as the control information from the base station device to which the terminal device is connected to maintain the connection; whereas the terminal device, in the MBSFN subframe, waits for transmission of the information relating to the MBMS, regardless of presence/absence of the specific information required to maintain the connection. Further, since the MBMS is a broadcast service, i.e., a service based on broadcast, even if the terminal device could not receive the information relating to the MBMS, the terminal device does not perform an operation in response to that it could not receive the information.

Therefore, the terminal device, in the section of the MBSFN subframe, can maintain the connection to the base station device without receiving the specific information from the base station device.

That is, in the section of the MBSFN subframe and in a section included in the MBSFN subframe, the base station device need not transmit, to the terminal device connected to the base station device, the specific information required to maintain the connection with the terminal device.

Referring back to FIG. 4, upon receiving the information relating to the provision of the MBMS from the upper layer, the setting unit 24 causes the resource allocation unit 23 to include the MBSFN subframe application information in the SIB1 to be transmitted by the PDSCH of the downlink signal, and to apply the MBSFN subframe to the subframe specified by the application information among the downlink subframes of the femto BS 1b.

Further, upon receiving, from the synchronization processing unit 22, a notification (timing information) indicating the timing to acquire the downlink signal from the another base station device 1, the setting unit 24 causes the resource allocation unit 23 to include, in the SIB1, application information indicating that the MBSFN subframe is to be applied to the subframe corresponding to the acquisition timing, and to apply the MBSFN subframe to the subframe specified by the application information. That is, although there is actually no information provided by the MBMS from the upper layer, the setting unit 24 applies the MBSFN subframe in a pseudo manner to the subframe corresponding to the acquisition timing, and thereby each MS 2 connected to the femto BS 1b recognizes that the MBSFN subframe is applied to the subframe, and waits for information provided by the MBMS.

As described above, the setting unit 24 sets, in the downlink signal of the femto BS 1b, the MBSFN subframe that is a section in which it is not necessary to transmit, to the terminal device connected to the femto BS 1b, the specific information required to maintain the connection with the terminal device, in accordance with the information from the upper layer or the notification from the synchronization processing unit 22.

The resource allocation unit 23 does not allocate a resource specific to each MS 2 to the MBSFN subframe for transmitting the information relating to the MBMS. Even when receiving the notification indicating the acquisition timing from the synchronization processing unit 22, the resource allocation unit 23 does not allocate a resource specific to each MS 2 to the subframe corresponding to the acquisition timing.

Hereinafter, a specific manner of the synchronization process will be described.

[1.4 Synchronization process]

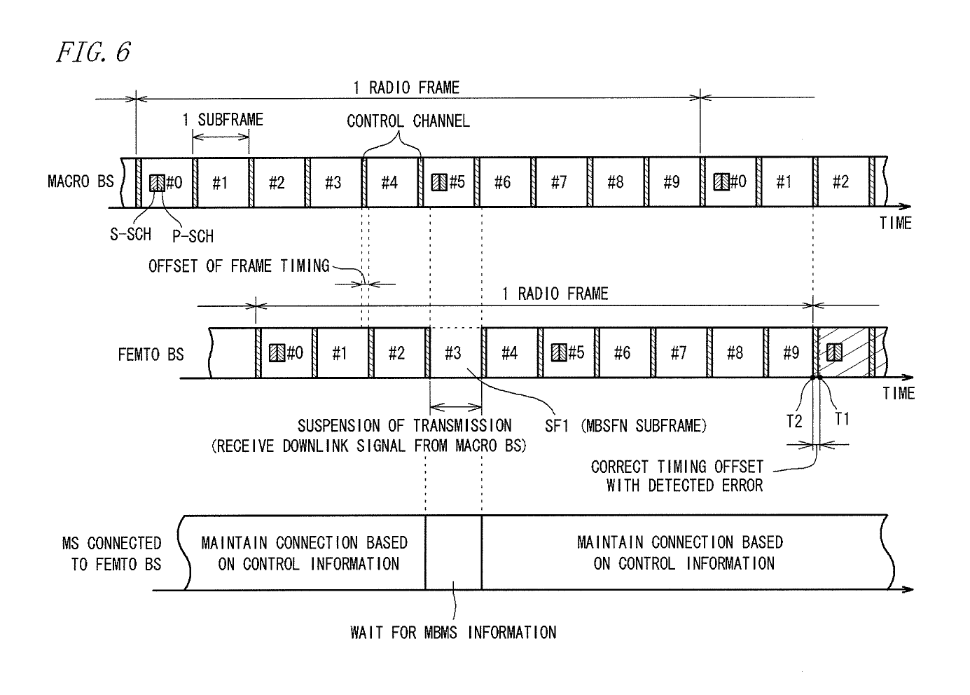

FIG. 6 is a diagram for explaining an example of a manner of a synchronization process performed by the synchronization processing unit. FIG. 6 shows a frame transmitted by a macro BS 1a as another base station device and a frame transmitted by a femto BS 1b on the same time axis, and shows a manner in which the femto BS 1b performs synchronization with a downlink signal from the macro BS 1a serving as a synchronization source.

FIG. 6 shows a state in which an offset has occurred in the subframe transmission timings: that is, in each section before timing T2, the transmission timing of the radio frame of the femto BS 1b is shifted in the time axis direction by substantially two subframes being delayed relative to the corresponding transmission timing of the radio frame of the macro BS 1a, and a timing offset has occurred between the beginning of each subframe of the femto BS 1b and the beginning of a corresponding subframe of the macro BS 1a transmitted almost concurrently.

When the femto BS 1b of the present embodiment is activated, the synchronization processing unit 22 of the femto BS 1b attempts to acquire downlink signals from neighboring base station devices, before transmission of a downlink signal from the femto BS 1b is started.

As described above, when receiving a downlink signal from the macro BS 1a, the synchronization processing unit 22 adjusts the timing of the radio frame of the femto BS 1b such that the transmission timings of the first subframe #0 and the sixth subframe #5 in its own radio frame, to each of which the P-SCH and the S-SCH are allocated, coincide with the transmission timings of subframes other than the first subframe #0 or the sixth subframe #5 in the radio frame of the downlink signal from the macro BS 1a serving as the synchronization source, to each of which the P-SCH and the S-SCH are allocated.

For example, it is assumed that, at the time of activation of the femto BS 1b, the synchronization processing unit 22 has adjusted the position of the own radio frame to be delayed by two subframes, such that the transmission timing of the own radio frame (the transmission timing of the first subframe #0) coincides with the transmission timing of the third subframe #2 of the macro BS 1a serving as the synchronization source.

Further, also in the inter-base-station synchronization process performed as needed thereafter, the synchronization processing unit 22 performs the synchronization process such that the transmission timing of the own radio frame (the transmission timing of the first subframe #0) coincides with the transmission timing of the third subframe #2 of the macro BS 1a as the another base station device.

As described above, as shown in FIG. 6, the transmission timing of the P-SCH and S-SCH in the downlink signal of the femto BS 1b is made to be different from the transmission timing of the P-SCH and S-SCH in the downlink signal of the macro BS 1a, and the transmission timing of the radio frame of the femto BS 1b is shifted in the time axis direction by substantially two subframes relative to the transmission timing of the corresponding radio frame of the macro BS 1a.

Here, if the synchronization processing unit 22 of the femto BS 1b has set, to a subframe SF1 (in FIG. 6, the section of the subframe #3), the timing to acquire a downlink signal for performing the synchronization process, the synchronization processing unit 22 notifies the setting unit 24 of information for specifying the subframe SF1 as information indicating the acquisition timing.

The setting unit 24 controls the resource allocation unit 23 so that, based on the information indicating the acquisition timing, which has been notified by the synchronization processing unit 22, the resource allocation unit 23 includes, in the SIB1 for each MS 2 currently connected to the femto BS 1b, application information indicating that the MBSFN subframe is applied to the subframe corresponding to the acquisition timing, i.e., the subframe SF1.

The subframe including the SIB1 is transmitted, and each MS 2 that receives the SIB1 recognizes that the MBSFN subframe is applied to the subframe SF1.

The synchronization processing unit 22 causes the transmission unit 13 to suspend transmission of a transmission signal during a section other than the control channel in the subframe SF1 to which the MBSFN subframe is applied by the resource allocation unit 23, while acquiring the downlink signal of the macro BS 1a which has been received by the downlink signal reception unit 12.

Then, the synchronization processing unit 22 detects the transmission timing of the subframe of the macro BS 1a, by using the P-SCH and S-SCH contained in the acquired downlink signal of the macro BS 1a, and detects a frame synchronization error between the own frame transmission timing and the frame transmission timing of the macro BS 1a.

On the other hand, since each MS 2 connected to the femto BS 1b recognizes that the MBSFN subframe is applied to the timing of the subframe SF1, the MS 2 waits for transmission of information relating to the MBMS as shown in FIG. 6, regardless of presence/absence of the specific information required to maintain the connection.

Therefore, even if the femto BS 1b does not transmit the specific information required for each MS 2 to maintain the connection due to its suspension of transmission of the downlink signal in the subframe SF1, each MS 2 does not perform unnecessary scanning of base stations, and does not recognize that any abnormality occurs.

Further, in the subframes subsequent to the subframe SF1 to which the MBSFN subframe is applied, the femto BS 1b performs transmission of control information to each MS 2, smooth communication is maintained between the femto BS 1b and each MS 2.

Based on the detected frame synchronization error, the synchronization processing unit 22 adjusts the timing of the beginning of a radio frame next to the radio frame to which the subframe SF1 belongs, thereby achieving synchronization. For example, assuming that the beginning of the radio frame before synchronization is performed is timing T1, the synchronization processing unit 22 corrects the value of the frame counter such that the beginning of the radio frame coincides with timing T2 which is shifted from the timing T1 by an amount of the above-mentioned error. This allows the frame timing of the femto BS 1b to coincide with the frame timing of the macro BS 1a, whereby synchronization is achieved.

Since the radio frame of the femto BS 1b is already delayed by two subframes relative to the corresponding radio frame of the macro BS 1a in the above case, the synchronization processing unit 22 achieves synchronization with reference to the current frame position.

Although only the synchronization of the frame timing has been described, correction of the carrier frequency is also performed in a similar manner.

[1.5 Effects]

The femto BS 1b configured as described above acquires the downlink signal of the macro BS 1a as another base station device and detects the P-SCH and the S-SCH, during the section of the MBSFN subframe in which it is not necessary to transmit the specific information required for connection between the femto BS 1b and each MS 2 connected thereto. Therefore, even if transmission of a downlink signal from the femto BS 1b is suspended during the section of the MBSFN subframe, each MS 2 connected to the femto BS 1b can maintain the connection without being influenced by that no control information is transmitted. As a result, it is possible to acquire the downlink signal from the another base station device while suppressing influence on communication of each MS 2.

Further, in the above-described embodiment, based on the notification of the acquisition timing from the synchronization processing unit 22, the setting unit 24 sets a subframe to which the MBSFN subframe is to be applied, to a subframe corresponding to the acquisition timing. Therefore, even if the synchronization processing unit 22 performs inter-base-station synchronization at an arbitrary timing, the setting unit 24 can set the MBSFN subframe in the section in which the downlink signal from the macro BS 1a is received. Therefore, it is possible to more reliably suppress influence on each MS 2 at the time of acquisition of the downlink signal from the macro BS 1a.

Further, in the above-described embodiment, transmission of the downlink signal is suspended during the section other than the control channel in the subframe SF1 to which the MBSFN subframe is applied. However, transmission of the downlink signal may be suspended with respect to the control channel, because, as described above, the control channel formed by two symbols at the beginning of the MBSFN subframe is given only minimum necessary control information indicating that the corresponding subframe is an MBSFN subframe, and each MS 2 connected to the femto BS 1b recognizes the timing of the subframe to which the MBSFN subframe is applied.

The MBSFN subframe cannot be applied to subframes including the P-SCH and the S-SCH and subframes next to these subframes (in FIG. 6, subframes #0, #1, #5, and #6) due to the standard. Accordingly, the femto BS 1b is configured to adjust the transmission timing of its own subframe such that the transmission timing of any of the subframes #2 to #4 or the subframes #7 to #9 of the femto BS 1b coincides with the timing of the subframe #0 or #5 (subframe including the P-SCH and S-SCH) of the macro BS 1a to achieve synchronization.

Accordingly, although in the above-described embodiment an exemplary case has been described in which the position of the own radio frame is adjusted so as to be delayed by two subframes relative to that of the another base station device, it is possible to perform acquisition of the downlink signal of the macro BS 1a by utilizing the MBSFN subframe, as long as the position of the radio frame is set so that the transmission timing of any of the subframes #2 to #4 or the subframes #7 to #9, to which the MBSFN subframe can be applied, coincides with the timing of the subframe #0 or #5 (subframe including the P-SCH and S-SCH) of the macro BS 1a.

### 2. Second Embodiment

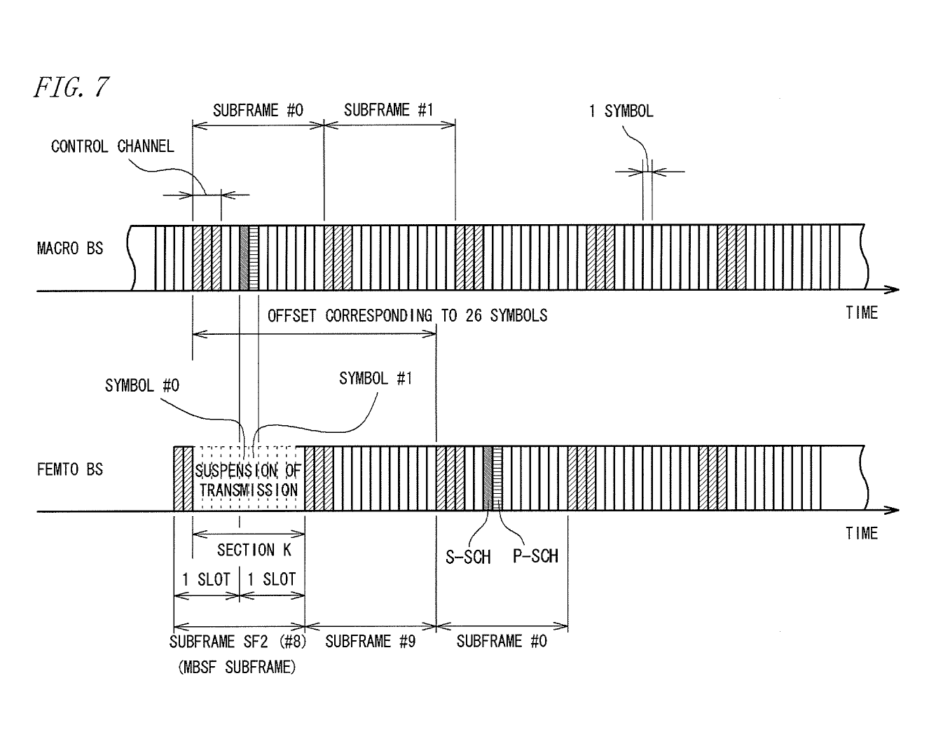

FIG. 7 is a diagram for explaining an example of a manner of a synchronization process according to a second embodiment of the present invention in Chapter 1. FIG. 7 shows a radio frame transmitted by a macro BS 1a as another base station device and a radio frame transmitted by a femto BS 1b, in units of modulation symbols, on the same time axis.

The present embodiment is different from the first embodiment in the following points: the synchronization processing unit 22 causes the transmission timing of its own downlink signal to coincide with that of another base station device in units of modulation symbols, thereby performing inter-base-station synchronization; and the synchronization processing unit 22 sets an MBSFN subframe such that the timing of the P-SCH and S-SCH is located substantially in the middle of a section in the MBSFN subframe, in which transmission of a downlink signal is suspended, and adjusts the position of the radio frame of the own downlink signal in the time axis direction.

More specifically, the synchronization processing unit 22 adjusts the own radio frame to achieve synchronization such that: the timing of the own P-SCH and S-SCH is offset by a time period corresponding to a predetermined number of symbols (in FIG. 7, 26 symbols) from the timing at which the timing of the own P-SCH and S-SCH coincides with the timing of the P-SCH and S-SCH of the another base station device, whereby the transmission timing of the synchronization signal of the femto BS 1b is different from that of the another base station device; and then the transmission timings of the own modulation symbols (hereinafter also referred to simply as “symbols”) coincide with those of the another base station device.

The synchronization processing unit 22 of the present embodiment has a function of adjusting the timing of the own radio frame (the position in the time axis direction) when receiving, at the time of activation of the femto BS 1b and the time of synchronization process, a downlink signal of the macro BS 1a as another base station device, such that the transmission timing of the P-SCH and S-SCH in the radio frame of the downlink signal from the macro BS 1a serving as a synchronization source is located within the range of subframes in the own radio frame, which do not contain the P-SCH and S-SCH (subframes other than the first subframe or the sixth subframe #5).

More specifically, the synchronization processing unit 22 adjusts the timing of the own radio frame such that the transmission timing of the P-SCH and S-SCH in the radio frame of the downlink signal from the macro BS 1a is located substantially in the middle of a section K other than the control channel in the subframe in the own radio frame.

For example, it is assumed that, as shown in FIG. 7, at the time of activation of the femto BS 1b, the synchronization processing unit 22 has adjusted the timing of the own radio frame, by causing the transmission timings of the first symbol #0 and the second symbol #1 in the rear-side slot of the own ninth subframe #8 to coincide with the transmission timing(s) of (the symbols containing) the P-SCH and S-SCH of the macro BS 1a, respectively, thereby locating the transmission timing of the P-SCH and S-SCH of the macro BS 1a substantially in the middle of the section K in the own radio frame.

Further, also in the inter-base-station synchronization process performed as needed thereafter, the synchronization processing unit 22 performs the synchronization process such that the transmission timings of the above-described symbols in the ninth subframe 18 of the own radio frame coincide with the transmission timing of the P-SCH and S-SCH of the macro BS 1a as another base station device.

If the synchronization processing unit 22 of the femto BS 1b sets the timing to acquire the downlink signal of the macro BS 1a for the synchronization process, to the subframe SF2 (subframe #8) shown in FIG. 7, the synchronization processing unit 22 causes the resource allocation unit 23 to apply an MBSFN subframe to the subframe SF2, as in the first embodiment.

The synchronization processing unit 22 causes the transmission unit 13 to suspend transmission of a transmission signal, during the section K other than the control channel in the subframe SF2 to which the MBSFN subframe is applied by the resource allocation unit 23, while acquiring the downlink signal of the macro BS 1a, which has been received by the downlink signal reception unit 12. The control channel in the subframe to which the MBSFN subframe is applied has a width corresponding to two symbols, and as described above, minimum necessary information such as information indicating that the corresponding subframe is an MBSFN subframe is stored in the control channel.

The synchronization processing unit 22 performs the synchronization process with the macro BS 1a by utilizing the P-SCH and S-SCH contained in the acquired downlink signal of the macro BS 1a.

Also in the present embodiment, since the P-SCH and S-SCH of the macro BS 1a as another base station device are acquired during the section K included in the MBSFN subframe which is a section in which it is not necessary to transmit the specific information required for connection with each MS 2 connected to the femto BS 1b, even if transmission of the downlink signal of the femto BS 1b is suspended during the section K, each MS 2 connected to the femto BS 1b can maintain the connection without being influenced by that no control information is transmitted. As a result, it is possible to acquire the downlink signal of the another base station device while suppressing influence on communication of each MS 2.

The femto BS 1b needs to suspend transmission of the own downlink signal and start reception of the downlink signal of the macro BS 1a, at the beginning of the section K, in order to acquire the P-SCH and S-SCH of the macro BS 1a, and further needs to suspend the reception and start the transmission of the own downlink signal again at the end of the section K. Thus, it is necessary to perform switching between the reception and the transmission before and after the reception of the P-SCH and S-SCH, within a relatively short time period such as the section K in the subframe.

In this regard, in the present embodiment, the synchronization processing unit 22 adjusts the timing of the own radio frame such that the transmission timing of the P-SCH and S-SCH in the radio frame of the downlink signal of the macro BS 1a is located substantially in the middle of the section K in the own radio frame. Accordingly, it is possible to secure a time margin before and after the timing at which the P-SCH and S-SCH of the macro BS 1a are received.

That is, the synchronization processing unit 22 adjusts the positions, in the time axis direction, of the section K and the own downlink signal such that a time period is secured which is necessary for processing for acquisition of the downlink signal from the macro BS 1a, such as the reception/transmission switching before and after the transmission timing of the P-SCH and S-SCH of the macro BS 1a.

As a result, it is possible to secure a time margin before and after the timing at which the P-SCH and S-SCH of the macro BS 1a are received. Thus, it is possible to reliably acquire the P-SCH and S-SCH of the macro BS 1a even when the reception/transmission switching is performed before and after the reception of the P-SCH and S-SCH.

Transmission of the downlink signal may be suspended with respect to the control channel because, as described above, the control channel is given only the minimum necessary control information indicating that the corresponding subframe is an MBSFN subframe, and each MS 2 connected to the femto BS 1b recognizes the timing of the subframe to which the MBSFN subframe is applied. In this case, the synchronization processing unit 22 may adjust the timing of the own radio frame such that the timing of the P-SCH and S-SCH of the macro BS 1a is located substantially in the middle of the entire subframe SF2.

### 3. Third Embodiment

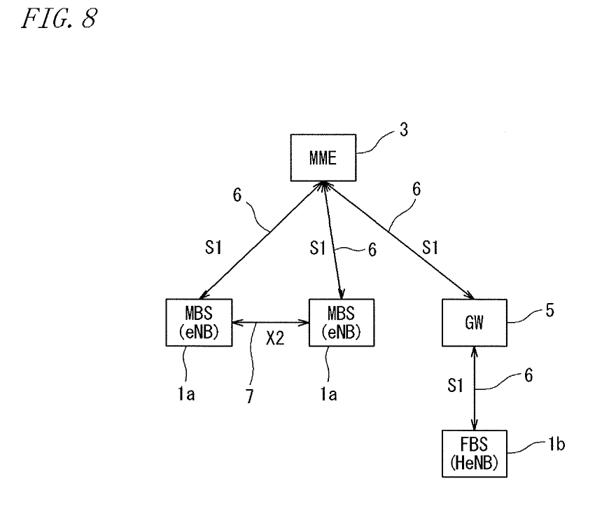

FIG. 8 is a diagram showing an inter-base-station network for connecting BSs 1 in a wireless communication system according to a third embodiment of the present invention.

In the present embodiment, BSs 1a and 1b form an inter-base-station network for performing inter-base-station communication with each other. Each of macro BSs 1a (eNB) is connected to an MME (Mobility Management Entity) 3 via a line 6 using a communication interface called “S1 interface”. The MME 3 is a management unit that manages the positions and the like of terminal devices 2, and is a node that performs a process for mobility management for each terminal device 2.

Further, the macro BSs 1a are connected to each other via a line 7 using a communication interface called “X2 interface”, and are allowed to communicate with each other to directly exchange information.

The femto BS 1b (HeNB) is connected to the MME 3 via an HeNB gateway (GW) 5. Connection between the MME 3 and the GW 5 and connection between the GW 5 and the femto BS 1b are each also achieved by a line 6 using a communication interface called “S1 interface”.

The femto BS 1b may be connected to the MME 3 by the S1 interface without the intervening GW 5.

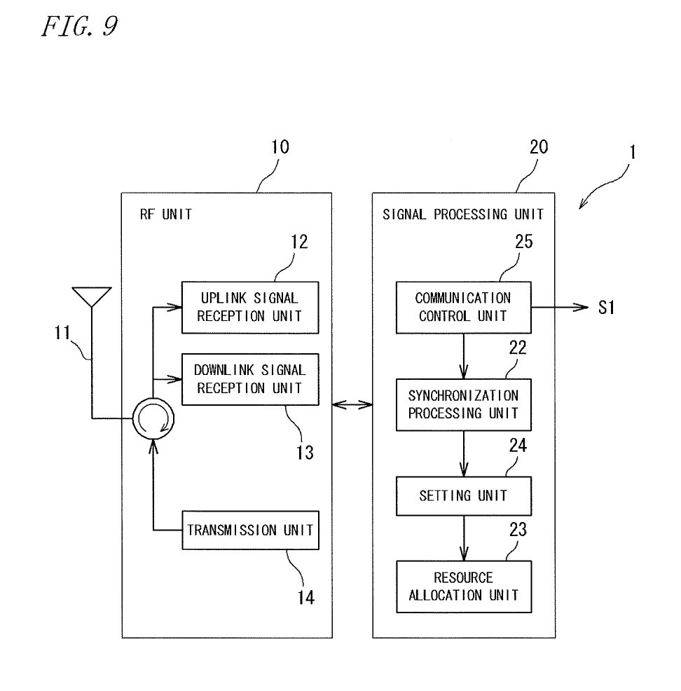

FIG. 9 is a block diagram showing the configuration of the femto BS 1b. The signal processing unit 20 of the femto BS 1b of the present embodiment further includes a communication control unit 25 for performing inter-base-station communication using the S1 network, in addition to the function units described for the first embodiment. The macro BS 1a also includes a communication control unit that realizes an inter-base-station communication function using the X2 interface as well as the S1 interface, and the configuration of the macro BS la is almost the same as that of the femto BS 1b.

[3.1 Blank section]

The macro BS 1a and the femto BS 1b of the present embodiment each have a function of setting, in its own downlink signal, a blank section for suppressing interference to another BS.

The blank section is a section in which, for the purpose of interference suppression, signal transmission is not performed at all or substantial signal transmission is not performed, depending on a base station device in which the blank section is set, and it is a section in which use of a radio resource by the base station device is limited. In the blank section, use of the radio resource by the base station device in which the blank section is set is limited, and thereby interference to another BS is suppressed.

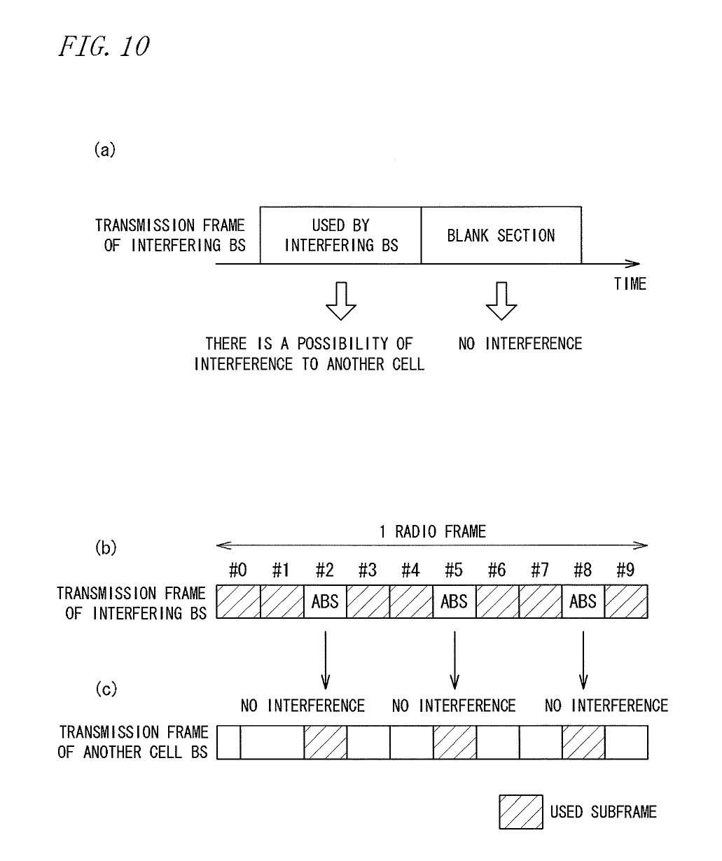

When the blank section is set in a DL frame of a BS that is likely to cause interference to another cell, since use of the blank section by the BS is limited to the extent that it does not influence another cell, it is possible to suppress interference to an MS in the another cell as shown in FIG. 10(a).

In other words, in the blank section, it is possible to cause a base station device other than the base station device in which the blank section is set in its downlink signal, to actively use the resource in the time zone corresponding to the blank section.

FIG. 10(b) shows a case in which an interference-causing BS provides, as an example of the blank section, an ABS (Almost Blank Subframe) in its DL frame. The ABS is “Almost Blank Subframe” described in a technical specification (TS36.300 V10.3.0 2011-03 16.1.5) of 3GPP (3rd Generation Partnership Project). The ABS is a section in which use of a radio resource by a BS is limited to the extent that it does not influence another cell, by reducing the transmission power with respect to some physical channels existing in the section, or by allocating only minimum data to some physical channels existing in the section, or by transmitting a minimum data signal or transmitting no data signal at all with respect to some physical channels existing in the section, or by reducing the amount of the radio resource to be used.

Further, as shown in FIG. 10(b), one or a plurality of ABS is set in a radio frame in a predetermined pattern.

As shown in FIG. 10(c), subframes in a BS in another cell, whose timings correspond to ABSs in an interference-causing BS, are subframes that are not interfered with by the interference-causing BS. Accordingly, the BS in the another cell can avoid interference from the interference-causing BS to an MS connected to the BS in the another cell, by performing transmission using the subframes at the timings corresponding to the ABSs in the interference-causing BS.

Accordingly, the BS in the another cell can suppress interference from the interference-causing BS by performing transmission using the subframes at the timings corresponding to the ABSs of the interference-causing BS, for an MS which is, for example, located near the cell edge of the another cell and therefore is highly likely to be interfered with by the interference-causing BS.

In order to utilize (the subframes at the timings corresponding to) the ABSs of the interference-causing BS, the BS in the another cell needs to previously recognize the schedule of ABSs set by the interference-causing BS. For this purpose, each BS transmits ABS pattern information indicating the setting pattern of ABSs, to BSs other than itself, via the above-described inter-base-station network.

By causing the BSs other than itself to recognize the ABS schedule, it is possible to cause the BSs to actively use the radio resource in the time zones corresponding to the blank sections.

[3.2 Utilization of ABS Pattern Information by Femto BS 1b]

When performing the synchronization process, the femto BS 1b of the present embodiment transmits the above-described ABS pattern information to neighboring BSs including the macro BS 1a serving as a synchronization source.

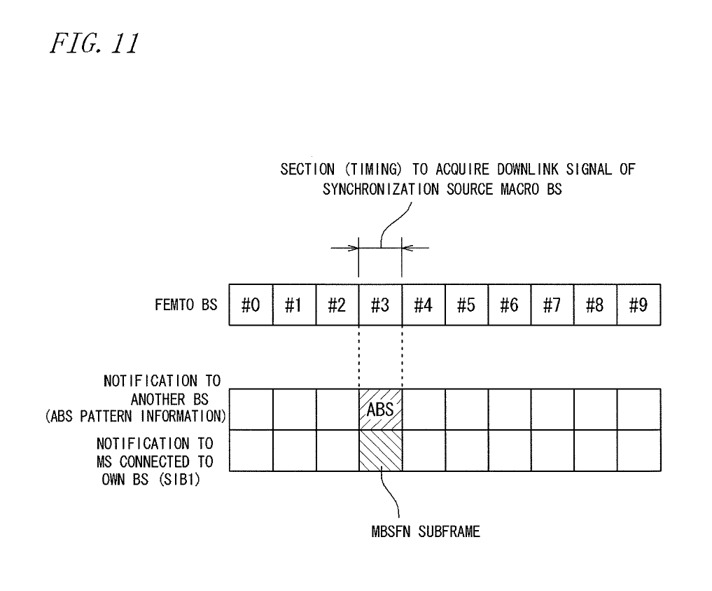

A specific description will be given of a case where the femto BS 1b sets, in a section corresponding to a subframe #3 in FIG. 11, the timing to acquire a downlink signal required to perform the synchronization process from the synchronization source BS (macro BS 1a).

When determining the timing to acquire the downlink signal from the synchronization source, the femto BS 1b includes, in the SIB1 for each MS 2 currently being connected to the femto BS 1b, application information indicating that an MBSFN subframe is applied to the section corresponding to the subframe #3 which is the acquisition timing. Upon receiving the SIB1, each MS 2 recognizes that the MBSFN subframe is applied to the section of the subframe #3.

Further, the femto BS 1b transmits ABS pattern information indicating that the section corresponding to the subframe #3 as the acquisition timing is an ABS, to the neighboring BSs including the macro BS 1a as the synchronization source. The communication control unit 25 of the femto BS 1b transmits the ABS pattern information to the neighboring BSs including the macro BS 1a as the synchronization source via the above-described inter-base-station network. Upon receiving the ABS pattern information, each of the neighboring BSs including the macro BS 1a as the synchronization source recognizes that the ABS is set in the section corresponding to the subframe #3.

As described above, the femto BS 1b notifies each MS 2 connected to the femto BS 1b that the MBSFN subframe is applied to the section corresponding to the subframe #3, and on the other hand, notifies the neighboring BSs including the macro BS 1a as the synchronization source that the ABS is set in the section corresponding to the subframe #3 regardless of whether the ABS is set, as shown in FIG. 11.

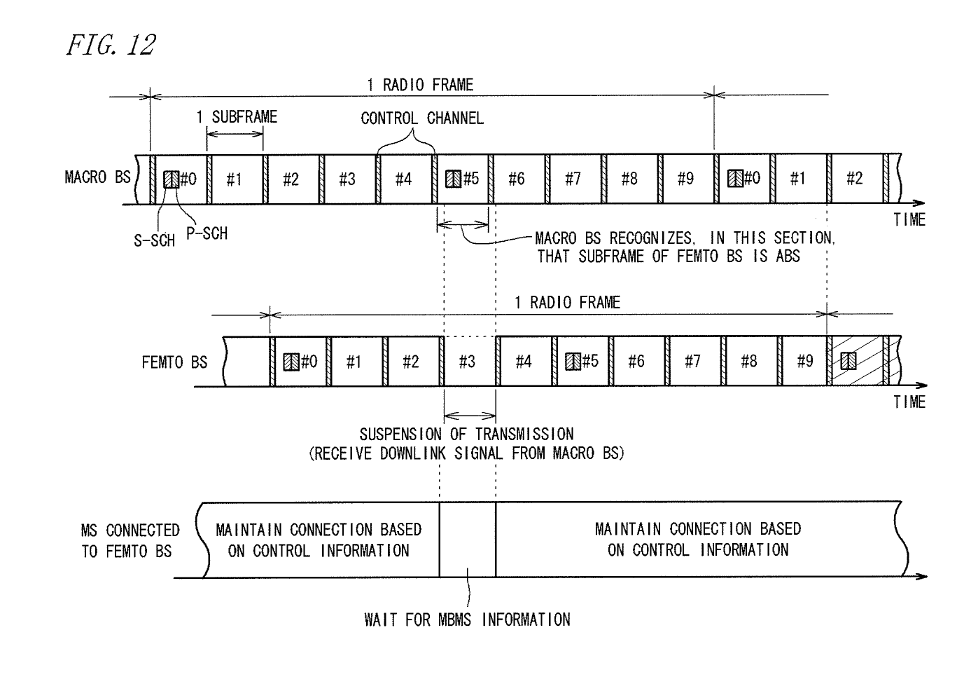

When reaching the section corresponding to the subframe #3, as shown in FIG. 12, the femto BS 1b suspends transmission of its own transmission signal, and receives and acquires the downlink signal of the macro BS 1a which is necessary for the synchronization process.

Meanwhile, each MS 2 connected to the femto BS 1b recognizes that the MBSFN subframe is applied to the section corresponding to the subframe #3, and therefore, the MS 2 waits for the information of the MBMS. Thus, the MS 2 does not perform unnecessary scanning of base stations, and does not recognize that any abnormality occurs. Therefore, the present embodiment is very useful.

On the other hand, each of the neighboring BSs including the macro BS 1a as the synchronization source recognizes that the ABS is set in the section corresponding to the subframe #3 of the femto BS 1b, and therefore, is caused to understand that interference by the femto BS 1b is suppressed.

That is, according to the present embodiment, the communication control unit 25 notifies the neighboring BSs including the macro BS 1a as the synchronization source that the section corresponding to the subframe #3 is the ABS regardless of whether it is the ABS, thereby to cause the neighboring BSs to recognize that the section is the ABS. Thereby, the neighboring BSs are caused to understand that interference by the femto BS 1b is suppressed in the section, and are prompted to use the section. As a result, it is possible to achieve active utilization of communication resources between the base station devices.

If the setting unit 24 suspends application of the MBSFN subframe to the above-described section, the communication control unit 25 may notify each MS 2 that the subframe for which application of the MBSFN subframe is suspended is not the ABS, before starting use of the subframe for which application of the MBSFN subframe is suspended.

In this case, it is possible to obviate interference that is likely to be caused by the femto BS 1b to another cell.

The present invention is not limited to the above-described embodiments. In each of the embodiments, based on the information indicating the acquisition timing notified by the synchronization processing unit 22, the setting unit 24 includes, in the SIB1 for each MS 2 currently being connected to the femto BS 1b, the application information indicating that the MBSFN subframe is applied to the subframe corresponding to the acquisition timing. Thereby, the setting unit 24 notifies each MS 2 of the timing of the subframe to which the MBSFN subframe is applied, and causes the MS 2 to recognize the timing.

At this time, the setting unit 24 previously notifies each MS 2 of the timing of the subframe to which the MBSFN subframe is applied. More specifically, when performing the notification, the setting unit 24 secures a time period during which each MS 2 can recognize that the MBSFN subframe is applied, between the timing at which the timing of the subframe to which the MBSFN subframe is applied is notified, and the timing of the subframe to which the MBSFN subframe is applied.

Thereby, the setting unit 24 can previously notify each MS 2 of the application information indicating that the MBSFN subframe is applied, to cause the MS 2 to recognize the same. Therefore, it is possible to more reliably suppress influence on communication of the MS 2 even if the femto BS 1b suspends transmission in the section.

Further, in the above-described embodiments, the synchronization processing unit 22 acquires the downlink signal of the another base station device, which has been received by the downlink signal reception unit 13, and performs the inter-base-station synchronization by using the downlink signal. However, the synchronization processing unit 22 may have a function of measuring the transmission status such as the transmission power and/or the operating frequency of the acquired downlink signal. In this case, it is possible to perform measurement of the downlink signal of the another base station device while suppressing influence on communication of the terminal device.

In the above-described embodiments, the synchronization process is performed in units of subframes, and in units of modulation symbols. However, the synchronization process may be performed in other units forming the downlink signal, such as radio frames, or sections demarcated by resource blocks.

In the above-described embodiments, in the synchronization process, the synchronization error is corrected at the beginning of a radio frame immediately after the transmission signal is suspended and the downlink signal of the macro BS 1a is received. However, the synchronization error may be corrected at the beginning of a subframe other than the beginning of a radio frame.

Note that the embodiment disclosed herein is merely illustrative in all aspects and should not be recognized as being restrictive. The scope of the present invention is defined by the scope of the claims rather than by the meaning described above, and is intended to include meaning equivalent to the scope of the claims and all modifications within the scope.

Further, the reference characters used in Chapter 1 are exclusively used in Chapter 1, and are not related to the reference characters in other chapters.

### DESCRIPTION OF REFERENCE CHARACTERS

1 base station device
12 downlink signal reception unit
22 synchronization processing unit (acquisition unit)
24 setting unit
25 communication control unit

### Chapter 2

Hereinafter, preferred embodiments of the present invention in Chapter 2 will be described with reference to accompanying drawings.

### 1. Background Art

In a conventional mobile communication system, wireless communication services have been provided by a base station device forming a cell (macro cell) having a radius of several hundreds of meters to several tens of kilometers.

In recent years, with introduction of LTE (Long Term Evolution), drastic increase in data communication traffic has been expected. So, it has been considered that small-size base station devices each forming a cell (such as a pico cell) whose radius is smaller than that of a macro cell are arranged in the range of the macro cell. (refer to 3GPP, “TS36.104 V10.0.0 Base Station (BS) radio transmission and reception”, 2010-09, for example).

By arranging the pico cells in the macro cell, the traffic is dispersed, and reduction in the throughput of the entire system is avoided.

Since the pico cells are arranged in the range of the macro cell, if a pico cell and the macro cell use the same communication frequency, a terminal device positioned near the cell edge of the pico cell is likely to be strongly interfered with by the macro cell.

That is, in an area around the center of the pico cell (around a small-size base station device that forms the pico cell), a radio wave from the small-size base station device that forms the pico cell is stronger than a radio wave from the base station device that forms the macro cell. Accordingly, the communication quality of a terminal device in the pico cell is relatively high.

However, as the terminal device moves away from the small-size base station device that forms the pico cell, the radio wave from the small-size base station device decreases. As a result, in an area near the cell edge of the pico cell, the terminal device is likely to be interfered with by the radio wave from the macro cell.

So, it is considered that a section (blank subframe) in which data transmission is not substantially performed by limiting use of the section is provided in a frame transmitted by the macro cell. When the macro cell is in the blank subframe, the terminal device in the pico cell is not interfered with by the macro cell. Accordingly, the terminal device in the pico cell performs communication by utilizing the blank subframe, and does not substantially perform communication in the section in which communication is performed by the macro cell, thereby suppressing reduction in the communication quality due to interference from the macro cell. Thus, even if the terminal device is positioned near the cell edge of the pico cell, reduction in the communication quality can be suppressed.

On the other hand, in order that the macro cell and the pico cell exert their functions in corporation with each other, it is preferred that inter-base-station synchronization for achieving synchronization of radio frame timings or the like is performed

For example, when a base station device that communicates with a terminal device by frequency division duplex (FDD) is caused to perform inter-base-station synchronization, the base station device needs to receive a downlink signal transmitted from another base station device serving as a synchronization source, in order to acquire a synchronization signal (known signal) from the another base station device.

At this time, since the downlink signal of the another base station device and the downlink signal of the base station device use the same frequency band, the base station device cannot perform transmission of its own downlink signal while receiving the downlink signal from the another base station device, and needs to suspend transmission of the own downlink signal at least during a time period when it receives the downlink signal from the another base station device.

However, if a section in which transmission of the own downlink signal is suspended is provided in addition to the blank subframe as described above, the number of sections the use of which is limited is increased in the base station device, which leads to a possibility that communication resources cannot be effectively utilized.

The present invention in Chapter 2 is made in view of the above situation, and an object of the present invention is to provide a base station device that can achieve effective utilization of communication resources.

### 2. Configuration Of Communication System

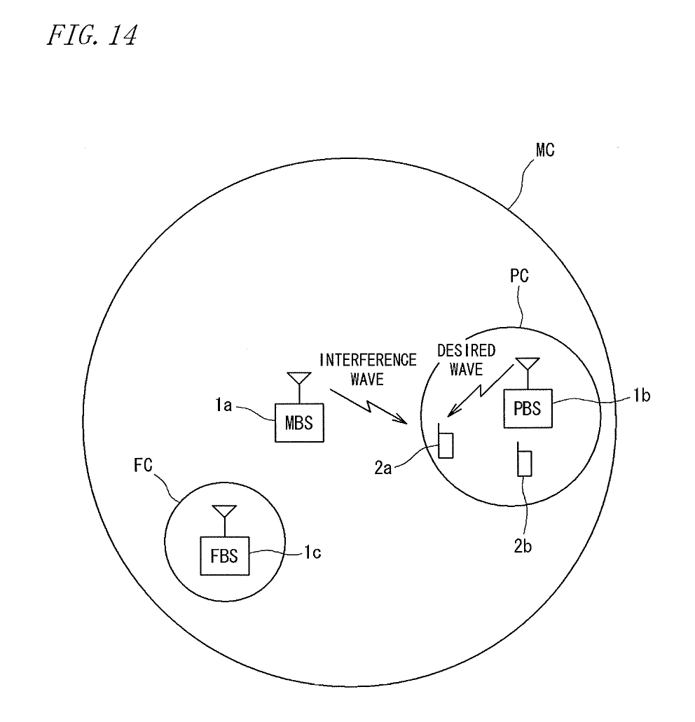

FIG. 14 is a schematic diagram showing a configuration of a wireless communication system. This communication system is a cell-type system including a plurality of base station devices (BS; Base Station) 1. The wireless communication system of the present embodiment is a system to which, for example, LTE is applied, and in which communication based on the LTE is performed between each base station device 1 and each terminal device (UE; User Equipment) 2. However, the communication scheme is not limited to the LTE.

The plurality of base station device 1 forming the communication system may include: a plurality of macro base station devices (Macro Base Stations) 1a each forming a communication area (macro cell) MC having a size of, for example, several kilometers; and small-size base station devices 1b and 1c each forming a cell smaller than the macro cell. Examples of the small-size base station devices include, for example, a pico base station device 1b forming a pico cell PC, and a femto base station device 1c forming a femto cell FC.

In the following description, a macro base station device is referred to as a macro BS, a pico base station device is referred to as a pico BS, and a femto base station device is referred to as a femto BS.

One or a plurality of pico BS 1b is installed in a macro cell. The pico BS 1b is installed mainly by a telecommunications operator, like the macro BS 1a. By connecting a terminal device (mobile terminal) 2 in the macro cell MC not to the macro BS 1a but to the pico BS 1b, the communication load of the macro BS 1a is reduced, and the throughput of the entire system is improved.

One or a plurality of femto BS 1c is installed in the macro cell. The femto BS lc is installed mainly by an individual or a company that is a customer (user) of the communication system. Installing the femto BS 1c allows, for example, improvement of communication environment in the place where it is installed.

The femto cell FC and the pico cell PC each have a communication area narrower than the macro cell MC, and generally, the femto cell FC is narrower than the pico cell PC, as indicated by their names “femto” and “pico”.

In the LTE, a macro BS and a pico BS are referred to as “eNB”, and a femto BS is referred to as “HeNB”.

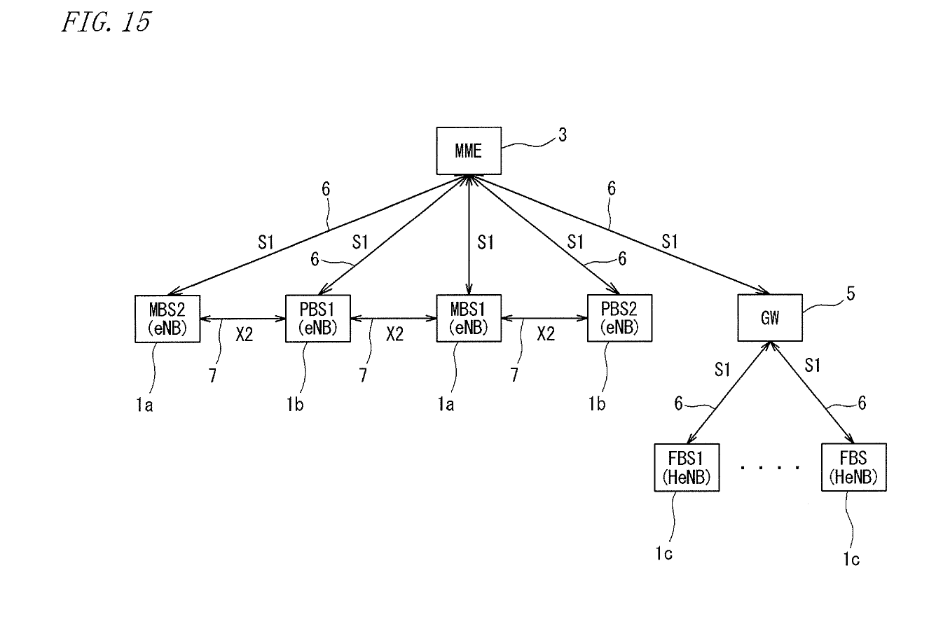

FIG. 15 shows an inter-base-station network (wired network) in which base station devices including macro BSs 1a, pico BSs 1b, and femto BSs 1c are connected. Each macro BS 1a and each pico BS 1b, i.e., each eNB, are connected to an MME (Mobility Management Entity) via a line 6 using a communication interface called “S1 interface”. The MME 3 is a management unit that manages the positions and the like of terminal devices 2, and is a node that performs a process for mobility management for each terminal device 2.

Further, the respective eNBs are connected to each other by a line 7 using a communication interface called “X2 interface”, and are allowed to communicate with each other to directly exchange information. However, in the current standard, the femto BS lc cannot have the X2 interface.

Connection using the X2 interface is not limited to that shown in FIG. 15, and the X2 interface may be provided between any two eNBs.

Each femto BS 1c as an HeNB is connected to the MME 3 via an HeNB gateway (GW) 5. Connection between the MME 3 and the gateway 5 and connection between the gateway 5 and the femto BS 1c are also achieved by a line 6 using the communication interface called “S1 interface”.

The femto BS 1c may be connected to the MME 3 by the S1 interface without an intervening HeNB gateway (GW) 5.

The network using the S1 interface and the X2 interface forms an inter-base-station network in which the respective base station devices 1a, 1b, and 1c are wire-connected. In the inter-base-station network, a server for managing communication (not shown) and the like are installed.

Between the respective base station devices 1a, 1b, and 1c, inter-base-station synchronization is secured by utilizing the inter-base-station network or the like.

### 3. Frame Structure for LTE

In the FDD scheme that can be adopted in the LTE on which the communication system of the present embodiment is based, uplink communication and downlink communication are simultaneously performed by allocating different operating frequencies to an uplink signal (a transmission signal from a terminal device to a base station device) and a downlink signal (a transmission signal from the base station device to the terminal device).

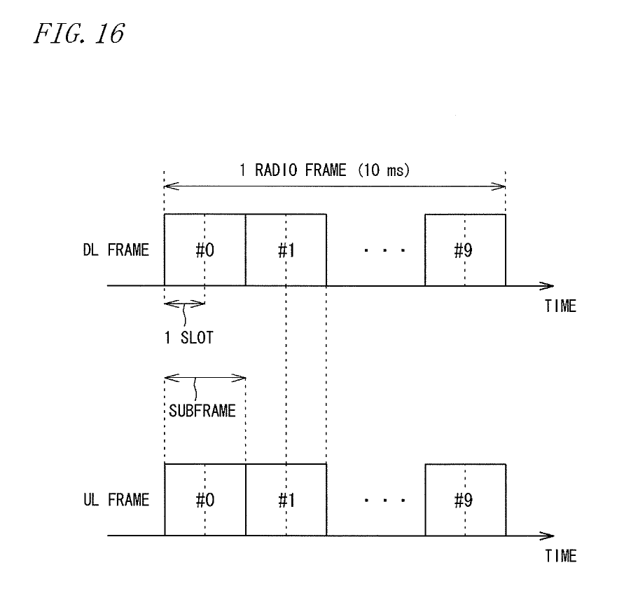

FIG. 16 is a diagram showing the structures of uplink and downlink radio frames for the LTE. Each of a downlink radio frame (DL frame) and an uplink radio frame (UL frame), which are the essential frames for the LTE, has a time length of 10 milliseconds per radio frame, and consists of 10 subframes #0 to #9 (each subframe is a communication unit area having a constant time length). The DL frame and the UL frame are arranged in the time-axis direction with their timings coinciding with each other.

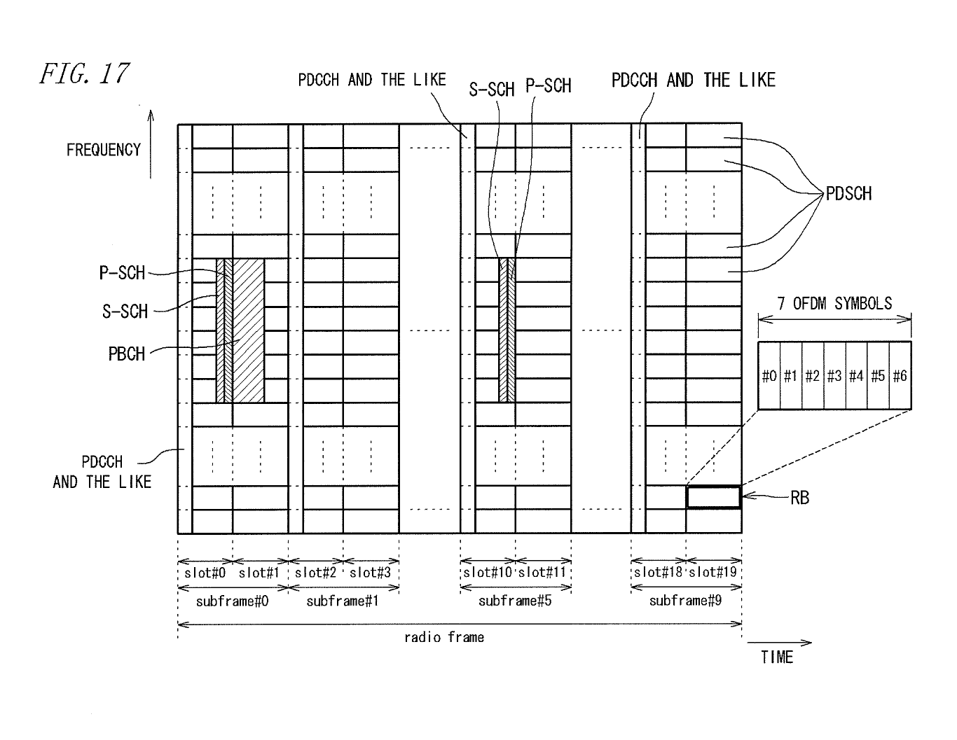

FIG. 17 is a diagram showing the structure of the DL frame (the transmission frame from the base station device) in detail. In FIG. 17, the vertical axis direction indicates the frequency, and the horizontal axis direction indicates the time.

Each of subframes that form the DL frame consists of 2 slots. Each slot consists of 7 (#0 to #6) OFDM symbols (in the case of Normal Cyclic Prefix).

Further, in FIG. 17, a resource block (RB) that is a fundamental unit area for data transmission is defined by 12 subcarriers in the frequency-axis direction and 7 OFDM symbols (1 slot) in the time-axis direction.

Further, for the bandwidth of the DL frame in the frequency direction, a plurality of set values are provided up to the maximum of 20 MHz.

As shown in FIG. 17, at the beginning of each subframe, a transmission area for allocating, to a terminal device 2 by a base station device 1, a control channel required for downlink communication is secured. This transmission area corresponds to symbols #0 to #2 (three symbols at maximum) in the front-side slot in each subframe. A PDCCH, a PCFICH, a PHICH, and the like are allocated in the transmission area.

Among the 10 subframes that form the DL frame, the 1st (#0) and 6th (#5) subframes are each allocated a primary synchronization channel (P-SCH) and a secondary synchronization channel (S-SCH) which are control signals for identifying a base station device or a cell.

In the DL frame, a physical broadcast channel (PBCH) is allocated to the first subframe #0. The PBCH notifies, by broadcasting, terminal devices of the frequency bandwidth and the like of the system. The PBCH is arranged, in the time-axis direction, in the position corresponding to symbols #0 to #3 in the rear-side slot in the first subframe #0 so as to have a width corresponding to 4 symbols, and arranged, in the frequency-axis direction, in the center of the bandwidth of the DL frame so as to have a width corresponding to 6 resource blocks (72 subcarriers). The PBCH is configured to be updated every 40 milliseconds by transmitting the same information over four frames.

The PBCH has, stored therein, master information blocks (MIB) containing the communication bandwidth, the radio frame number, and the like.

Resource blocks in which the above-described channels are not allocated are used as physical downlink shared channels (PDSCH) in which user data and the like are stored. The PDSCH is an area shared by a plurality of terminal devices.

Allocation of the user data stored in the PDSCH is notified to terminal devices by means of resource allocation information relating to downlink radio resource allocation, which is stored in the PDCCH allocated at the beginning of each subframe. The resource allocation information is information indicating radio resource allocation to each PDSCH, and allows each terminal device to know whether data directed to the terminal device is stored in the subframe.

The P-SCH, S-SCH, PBCH, PDCCH, and other control channels include various kinds of control signals required by each terminal device 2 to receive the data signal transmitted by the PDSCH. Therefore, if these control channels are subjected to radio wave interference, reception of the data signal transmitted by the PDSCH is adversely affected.

Further, in the PDSCH, control signals common to the respective terminal devices, control signals specific to the respective terminal devices, and the like are also stored in addition to the user data. The control signals stored in the PDSCH include, for example, broadcast information such as system information blocks (SIB).

The system information blocks include SIB1 to SIB9. The timing to transmit the SIB1 is designated by an MIB. Schedule information of SIB2 to SIB9 is contained in the SIB1. Accordingly, a terminal device 2 can read the broadcast information such as the SIB even when the terminal device 2 does not establish connection to the base station device 1. The number of SIB is not particularly limited.

### 4. Configuration of Base Station Device

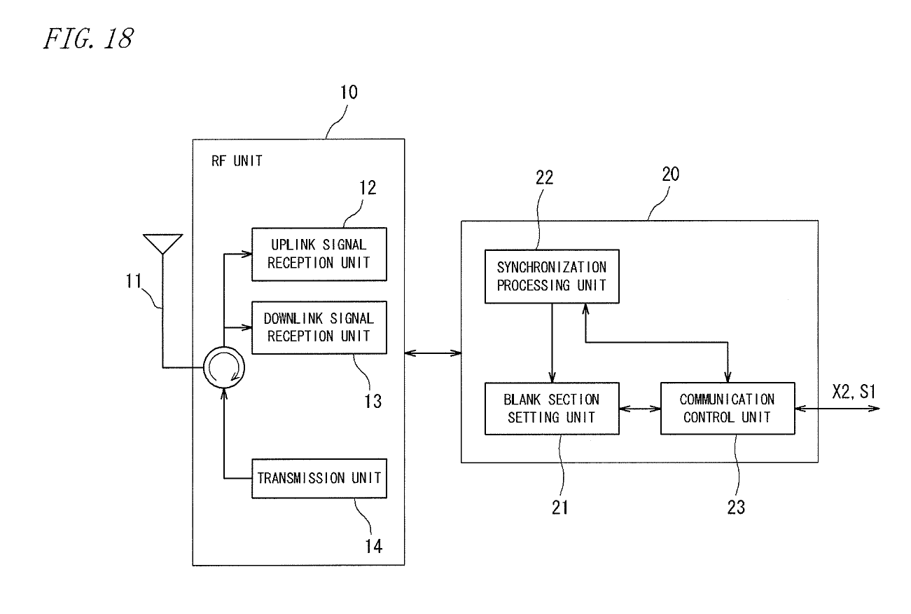

FIG. 18 is a block diagram showing the configuration of the macro BS 1a shown in FIG. 14. Although the configuration of the macro BS 1a will be described hereinafter, the configurations of the pico BS 1b and the femto BS 1c are almost the same as that of the macro BS 1a.

The macro BS 1a includes an antenna 11, a transmission/reception unit (RF unit) 10 to which the antenna 11 is connected, and a signal processing unit 20 which performs processing regarding inter-base-station synchronization with another base station device, in addition to signal processing of transmission and reception signals between MSs 2, which signals are exchanged between the signal processing unit 20 and the RF unit 10.

The RF unit 10 includes an uplink signal reception unit 12, a downlink signal reception unit 13, and a transmission unit 14. The uplink signal reception unit 12 receives an uplink signal from an MS 2. The downlink signal reception unit 13 receives downlink signals from another macro BS 1a, a pico BS 1b, and a femto BS 1c. The transmission unit 14 transmits a downlink signal to an MS 2.

The downlink signal received by the downlink signal reception unit 13 is provided to the signal processing unit 20, and processed by a synchronization processing unit 22 or a demodulation unit (not shown).

The signal processing unit 20 includes a blank section setting unit 21, a synchronization processing unit 22, and a communication control unit 23.

The synchronization processing unit 22 has a function as a setting unit for setting, in its own downlink signal, an acquisition section for acquiring a downlink signal from another BS 1, which has been received by the downlink signal reception unit 13.

The synchronization processing unit 22 also has a function of performing a synchronization process in which a P-SCH and an S-SCH as known signals contained in the downlink signal of the another BS 1 are acquired as synchronization signals during the acquisition section, and based on these signals, the transmission timing of the subframe in the radio frame of the macro BS 1a is made to coincide with that of the another BS 1, thereby achieving inter-base-station synchronization.

Inter-base-station synchronization may be performed by providing each of the base station devices with a GPS receiver so that the base station devices can achieve synchronization by using GPS signals, or by connecting the base station devices via a cable. However, the present embodiment adopts inter-base-station synchronization based on “over-the-air synchronization” in which synchronization is achieved by using radio signals (downlink signals).

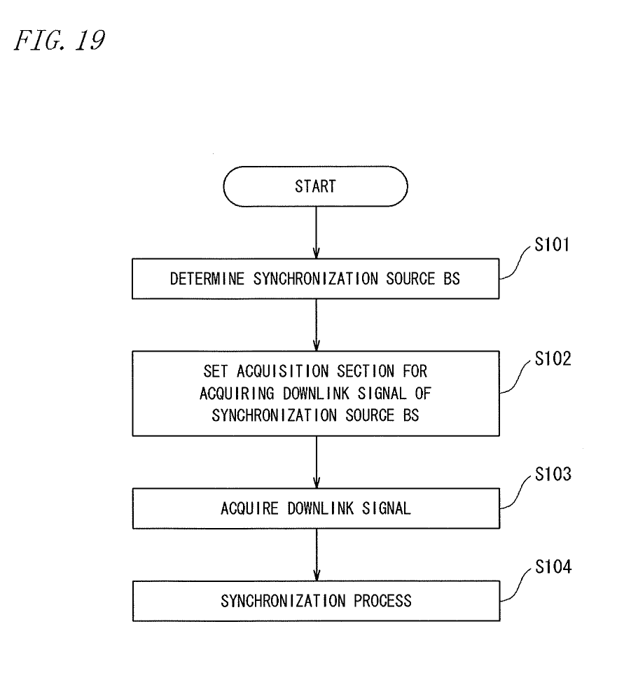

FIG. 19 is a flowchart showing process steps of the synchronization process performed by the synchronization processing unit 22.

The synchronization processing unit 22 determines to perform the synchronization process when the macro BS 1a is activated, or periodically, or in response to an external instruction. Then, the synchronization processing unit 22 firstly determines a BS 1 to be a synchronization source (step S101).

Thereafter, the synchronization processing unit 22 sets an acquisition section during which a downlink signal from the synchronization source BS 1 is acquired (step S102). During the acquisition section, the synchronization processing unit 22 causes the transmission unit 14 to suspend transmission of a downlink signal of the macro BS 1a, and acquires the downlink signal of the synchronization source BS 1 (step S 103).

Since the downlink signal of the synchronization source BS 1 and the downlink signal of the macro BS 1a use the same frequency band, the macro BS 1a cannot perform transmission of its own downlink signal while it is receiving the downlink signal of the synchronization source BS 1, and therefore, suspends transmission of the own downlink signal at least during the acquisition section.

Then, the synchronization processing unit 22 acquires the P-SCH and the S-SCH from the acquired downlink signal, and performs the synchronization process (step S 104).

Referring back to FIG. 18, the blank section setting unit 21 has a function of setting, in the downlink signal of the macro BS 1a, a blank section for suppressing interference to another cell.

The blank section is a section in which, for the purpose of interference suppression, signal transmission is not performed at all or substantial signal transmission is not performed, depending on a base station device in which the blank section is set, and it is a section in which use of the radio resource by the base station device is limited. In the blank section, use of the radio resource by the base station device in which the blank section is set is limited, and thereby interference to another cell is suppressed.

As shown in FIG. 14, a radio wave (interference wave) from the macro BS 1a easily reaches the terminal device 2a positioned near the cell edge of the pico cell PC, and moreover, the intensity of a radio wave (desired wave) from the pico BS 1b is low. Therefore, the terminal device 2a is likely to be interfered with by the macro BS 1a.

Since the relatively strong radio wave from the pico BS 1b reaches the terminal device 2b positioned near the center of the pico cell PC (near the pico BS 1b), the terminal device 2b is less likely to be interfered with by the macro BS 1a.

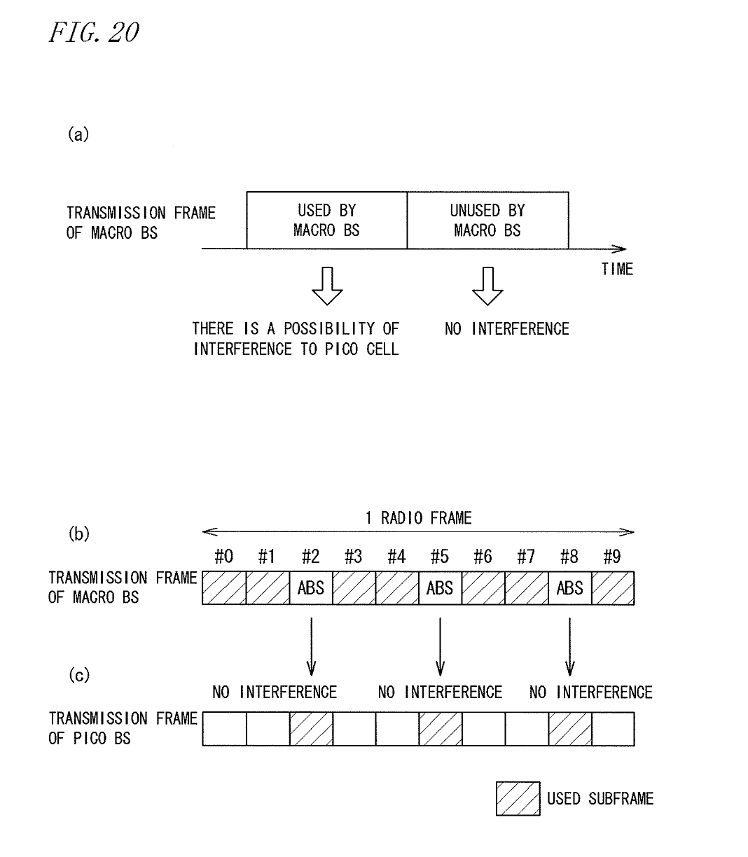

In order to suppress such interference from the macro BS 1a to the terminal device 2 positioned near the cell edge of the pico cell PC, as shown in FIG. 20(a), a section in which the macro BS 1a does not substantially use the radio resource is provided in the transmission frame of the macro BS 1a. The pico BS 1b performs, during the section not used by the macro BS 1a, transmission to the terminal device 2a connected to the pico BS 1b. Thereby, interference by the macro BS 1a is avoided.

In the present embodiment, the above-described blank section is set as the section in which the macro BS 1a does not substantially use the radio resource.

When the blank section is set in the DL frame of the macro BS 1a, since use of the blank section by the macro BS 1a is limited to the extent that it does not influence another cell including the pico BS 1b, interference to the MS in the another cell is suppressed.

In other words, in the blank section, it is possible to cause a base station device other than the macro BS 1a in which the blank section is set in its downlink signal, to actively use the resource in the time zone corresponding to the blank section.

FIG. 20(b) shows a case in which the macro BS 1a provides, as an example of the blank section, an ABS (Almost Blank Subframe) in its DL frame. The ABS is “Almost Blank Subframe” described in a technical specification (TS36.300 V10.3.0 2011-03 16.1.5) of 3GPP (3rd Generation Partnership Project). The ABS is a section in which use of the radio resource by a BS is limited to the extent that it does not influence another cell, by reducing the transmission power with respect to some physical channels existing in the section, or by allocating only minimum data to some physical channels existing in the section, or by transmitting a minimum data signal or transmitting no data signal at all with respect to some physical channels existing in the section, or by reducing the amount of the radio resource to be used.

Further, as shown in FIG. 20(b), one or a plurality of ABS is set in the radio frame in a predetermined pattern.

As shown in FIG. 20(c), the subframes of the pico BS 1b at the timings corresponding to the ABSs of the macro BS 1a are not interfered with by the macro BS 1a. Accordingly, the pico BS 1b performs transmission by using the subframes at the timings corresponding to the ABSs of the macro BS 1a, thereby avoiding interference from the macro BS 1a to the MS 2a connected to the pico BS 1b.

Accordingly, the pico BS 1b can suppress influence of interference from the macro BS 1a by performing transmission using the subframes at the timings corresponding to the ABSs of the macro BS 1a, for the MS 2a which is, for example, positioned near the cell edge of the pico cell PC and therefore is highly likely to be interfered with by the macro BS 1a.

In order to utilize (the subframes at the timings of) the ABSs of the macro BS 1a, the pico BS 1b needs to previously recognize the schedule of ABSs set by the macro BS 1a. For this purpose, the macro BS 1a transmits ABS pattern information indicating a patterned schedule of ABSs set in the downlink signal of the macro BS 1a, to BSs other than the macro BS 1a, via the above-described inter-base-station network.

By causing the other BSs including the pico BS 1b to recognize the ABS schedule, it is possible to cause the other BSs than the macro BS 1a to actively use the radio resource in the time zones corresponding to the blank sections.

The ABS pattern information is transmitted by the communication control unit 23 (FIG. 18). The communication control unit 23 of the macro BS 1a has a function of performing wired communication with the other BSs by using the 51 interface and the X2 interface that form the above-described inter-base-station network. The communication control unit 23 performs, in addition to transmission/reception of the ABS pattern information to/from the other BSs, transmission/reception of usable ABS pattern information which is a response from a BS that has received the ABS pattern information, to the transmission source of the ABS pattern information.

### 5. Setting of ABS

Basically, setting of ABSs is performed autonomously by a base station device. However, another base station device is allowed to adjust the ABS pattern of the base station device that performs setting of ABSs, through inter-base-station communication.

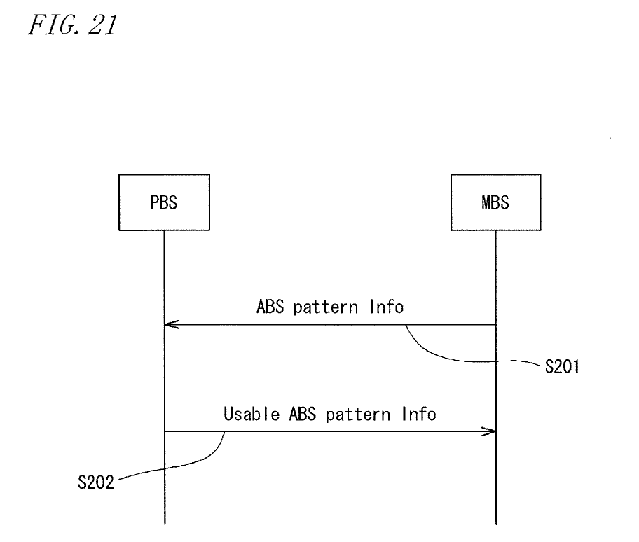

FIG. 21 is a diagram showing a manner of transmission/reception of information relating to the ABS pattern, which is performed by a base station device. FIG. 21 shows a case where the macro BS 1a (MBS) sets ABSs, and transmits/receives information relating to the ABS pattern to/from the neighboring pico BS 1b (PBS).

Firstly, the blank section setting unit 21 of the macro BS 1a determines the schedule of subframes in which ABSs are to be set, based on a predetermined standard. As described above, the schedule of ABSs is determined as a pattern of a plurality of subframe units, and is represented by ABS pattern information indicating the pattern of subframes set as ABSs.

When the blank section setting unit 21 has determined the ABS pattern, the communication control unit 23 transmits ABS pattern information (ABS Pattern Info) indicating the ABS pattern, to other BSs including the pico BS 1b, via the inter-base-station network (step S201).

Upon receiving the ABS pattern information, the pico BS 1b can recognize the ABS pattern of the macro BS 1a, and can actively utilize the sections of subframes corresponding to the ABSs, in which interference from the macro BS 1a can be avoided.

On the other hand, there is a case where the pico BS 1b determines that the pico BS 1b cannot use the ABSs of the ABS pattern transmitted from the macro BS 1a for some reason. Then, the pico BS 1b transmits usable ABS pattern information (Usable ABS Pattern Info) to the macro BS 1a (step S202). The usable ABS pattern information is information indicating either a pattern of subframes which are determined by the pico BS 1b to be protected from interference from other cells such as (other BSs including) the macro BS 1a, or a pattern or subframes which cannot be used as ABSs for protection from interference from other cells.

The blank section setting unit 21 of the macro BS 1a that has received the usable ABS pattern information compares the ABS pattern of the macro BS 1a to the usable ABS pattern transmitted from the pico BS 1b, and checks whether the ABS pattern of the macro BS 1a is determined as “usable” on the pico BS 1b side.

Upon confirming that the ABS pattern of the macro BS 1a is determined as “usable” on the pico BS 1b side, the blank section setting unit 21 sets ABSs by using the current ABS pattern.

On the other hand, when the ABS pattern of the macro BS 1a is determined as “unusable” on the pico BS 1b side, the blank section setting unit 21 repeatedly adjusts the ABS pattern and transmits the ABS pattern information, until it is determined as “usable” on the pico BS 1b side.

### 6. First Embodiment

Hereinafter, a description will be given of a case where, in the above-described wireless communication system, the macro BS 1a in which ABSs are set its own downlink signal, sets acquisition sections for inter-base-station synchronization.

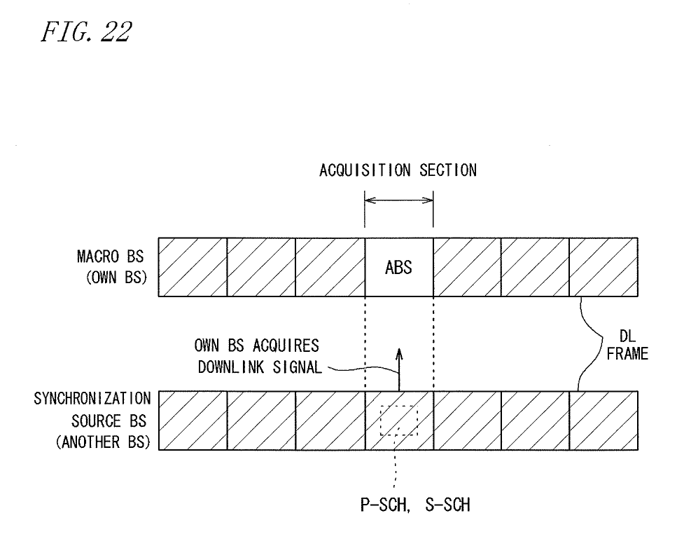

FIG. 22 is a diagram showing a part of a DL frame of the macro BS 1a according to the first embodiment, in association with a part of a DL frame of another base station device that is designated as a synchronization source by the macro BS 1a.

As shown in FIG. 22, the macro BS 1a, which is a base station device (own BS) of the present embodiment, sets an acquisition section for acquiring a downlink signal of the another base station device (another BS) as a synchronization source, such that the acquisition section overlaps an ABS section.

When determining execution of the synchronization process with the synchronization source BS and setting acquisition sections, the macro BS 1a firstly checks whether ABSs are set in its own downlink signal. When no ABS is set, the macro BS 1a appropriately sets acquisition sections, taking into consideration the conditions required to perform the synchronization process.

On the other hands, when ABSs are set, the macro BS 1a specifies subframes in which the ABSs are set, and sets acquisition sections in the subframes that satisfy the conditions required for the synchronization process, among the specified subframes.

In FIG. 22, the macro BS 1a sets the acquisition section so as to overlap the ABS section set by itself. Further, the subframe of the synchronization source BS, which corresponds to the timing of the ABS of the macro BS 1a, includes a P-SCH and an S-SCH. The macro BS 1a detects the P-SCH and the S-SCH by acquiring the downlink signal of the synchronization source BS, and performs the synchronization process.

During the acquisition section, the macro BS 1b suspends transmission of its own downlink signal in order to acquire the downlink signal of the synchronization source BS. However, since the acquisition section is set so as to overlap the ABS the use of which is limited, it is possible to suppress influence on the MS 2 connected to the macro BS 1b.

In the macro BS 1a of the above-described configuration, since the ABS is set in its own downlink signal, if the acquisition section is set at a timing different from the timing of the ABS, the ABS the use of which is limited and the acquisition section in which the downlink signal of the macro BS 1a needs to be suspended are arranged in parallel to each other in the downlink signal of the macro BS 1a, which might cause an increase in the number of sections the use of which is limited in the downlink signal.

In this regard, the synchronization processing unit 22 of the macro BS 1a of the present embodiment sets the acquisition section so as to overlap the ABS set in its own downlink signal. Since the acquisition section and the ABS, both of which are sections the use of which is limited, are overlapped with each other, the section the use of which is limited can be substantially reduced, thereby achieving effective utilization of communication resources.

While in the present embodiment the manner of setting the acquisition sections by the macro BS 1a has been described, the present embodiment is applicable not only to the macro BS 1a but also to the pico BS 1b and the femto BS 1c.

### 7. Second Embodiment

Next, a description will be given of a case where, in the above-described wireless communication system, the pico BS 1b which designates, as a synchronization source BS, the macro BS 1a in which ABSs are set in its downlink signal, sets acquisition sections for inter-base-station synchronization.

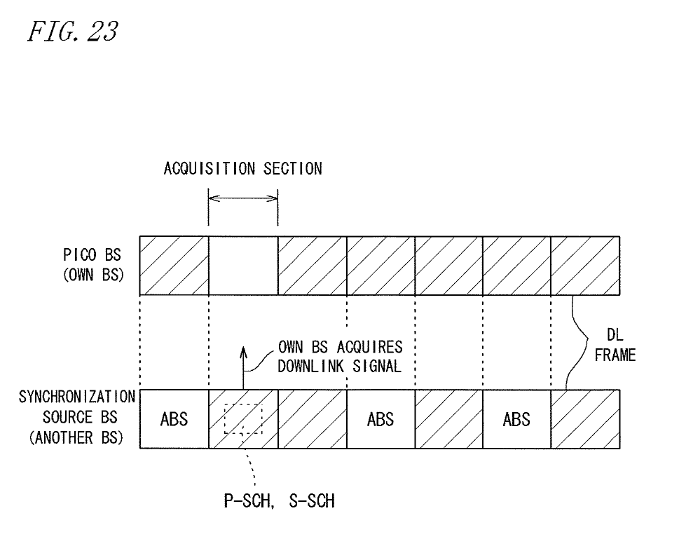

FIG. 23 is a diagram showing a part of a DL frame of the pico BS 1b according to the second embodiment, in association with a part of a DL frame of the macro BS 1a which is designated as a synchronization source by the pico BS 1b.

As shown in FIG. 23, the pico BS 1b which is a base station device (own BS) of the present embodiment designates, as a synchronization source, the macro BS 1a which is another base station device (another BS), and sets the acquisition section in a subframe at a timing that does not overlap the timing of the ABS set by the macro BS 1a.

When determining execution of the synchronization process and setting acquisition sections, the pico BS 1b firstly checks whether ABSs are set in the downlink signal of the macro BS 1a which is the synchronization source. The pico BS 1b can recognize the timings of the ABSs set in the macro BS 1a, by referring to the ABS pattern information transmitted from the macro BS 1a.

When no ABS is set in the macro BS 1a, the pico BS 1b appropriately sets acquisition sections, taking into consideration the conditions required to perform the synchronization process.

On the other hand, when ABSs are set in the downlink signal of the macro BS 1a, the pico BS 1b specifies subframes in which the ABSs are not set in the macro BS 1a, and sets acquisition sections in the subframes which satisfy the conditions required for the synchronization process, among the specified subframes.

As shown in FIG. 23, the pico BS 1b of the present embodiment sets the acquisition sections in the subframes at timings that do not overlap the timings of the ABSs set by the macro BS 1a.

For example, if the timing of the ABS set in the downlink signal of the macro BS 1a overlaps the timing of the acquisition section in the pico BS 1b, there is a possibility that the pico BS 1b cannot acquire the downlink signal of the macro BS 1a from the ABS the use of which is limited for interference suppression.

In this regard, the synchronization processing unit 22 of the present embodiment sets the acquisition sections at timings different from the timings of the ABSs set in the downlink signal of the macro BS 1a so that the acquisition sections do not overlap the ABSs. Thereby, the pico BS 1b can reliably acquire the downlink signal of the macro BS 1a, and actively utilize the ABSs set in the downlink signal of the macro BS 1a.

In the second embodiment, the pico BS 1b sets the acquisition sections in the subframes at the timings that do not overlap the timings of the ABSs set by the macro BS 1a designated as a synchronization source. However, the pico BS 1b may set the acquisition sections in subframes at timings that do not overlap the timings of ABSs set by another base station device which is not a synchronization source.

If the pico BS 1b sets the acquisition sections at timings that overlap the timings of the ABSs set by the another base station device which is not a synchronization source, the pico BS 1b should suspend transmission and cannot utilize the ABSs during the time periods in which the ABSs are set.

In contrast, if the pico BS 1b sets the acquisition sections in subframes at timings that do not overlap the timings of the ABSs set by the another base station device which is not a synchronization source, the pico BS 1b can actively utilize the ABSs set in the downlink signal of the another base station device which is not a synchronization source.

In the second embodiment, the present invention is applied to the relationship between the pico BS 1b and the macro BS 1a. However, the present invention is also applicable to the relationship between the femto BS 1c and the pico BS 1b, and to the relationship between the femto BS 1c and the macro BS 1a.

As described above, the BSs according to the first and second embodiments each include the synchronization processing unit 22 which sets, in its own downlink signal, acquisition sections for acquiring a downlink signal of another BS. The synchronization processing unit 22 sets the acquisition sections, based on the timings of ABSs for suppressing interference, which are set in the own downlink signal or a downlink signal of another BS. Therefore, it is possible to achieve effective utilization of communication resources by appropriately setting the relationship between the acquisition sections in which transmission of the own downlink signal should be suspended, and the timings of the ABSs the use of which is limited.

### 8. Third Embodiment

Hereinafter, a description will be given of a case wherein, in the above-described wireless communication system, the pico BS 1b sets acquisition sections in relation to ABSs set by the macro BS 1a which is not a synchronization source.

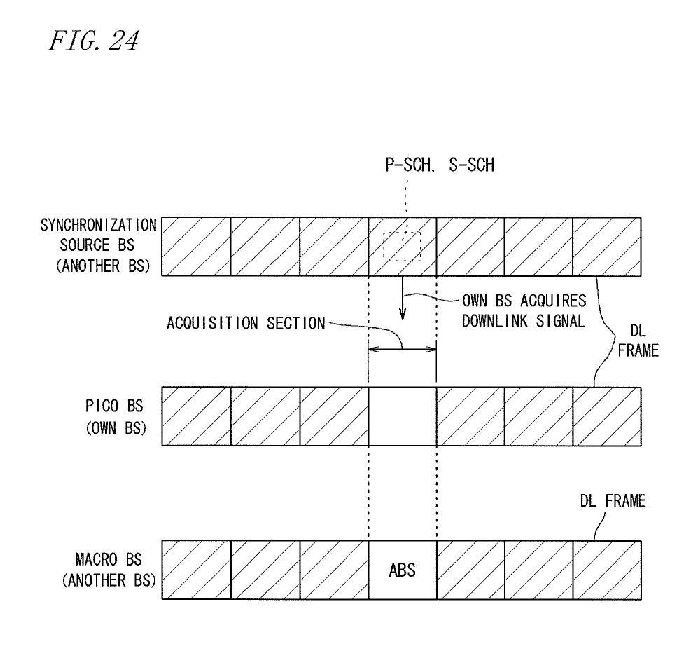

FIG. 24 is a diagram showing a part of a DL frame of the pico BS 1b according to the third embodiment, in association with a part of a DL frame of a synchronization source BS which is designated as a synchronization source by the pico BS 1b, and a part of a DL frame of the macro BS 1a which sets a macro cell MC to which the pico BS 1b belongs.

FIG. 24 shows a case where the pico BS 1b which is a base station device (own BS) of the present embodiment designates, as a synchronization source BS, another base station device (another BS) which is not the macro BS 1a. Further, in FIG. 24, the timing of the acquisition section set by the pico BS 1b overlaps the timing of the ABS set by the macro BS 1a which is another base station device (another BS) than the pico BS 1b.

When determining execution of the synchronization process and setting acquisition sections, the pico BS 1b firstly checks whether ABSs are set in a downlink signal of the another BS such as the macro BS 1a or the synchronization source BS. The pico BS 1b can recognize the timings of ABSs set in the another BS, by referring to the ABS pattern information transmitted from the another BS.

When no ABS is set in the another BS, the pico BS 1b appropriately sets acquisition sections, taking into consideration the conditions required to perform the synchronization process.

On the other hand, when ABSs are set in the downlink signal of the another BS, the pico BS 1b specifies subframes in which the ABSs are not set in the another BS, and sets acquisition sections in subframes that satisfy the conditions required for the synchronization process, among the specified subframes.

Here, there is a case where the pico BS 1b has to set the acquisition section in the subframe at the same timing as the timing of the ABS set by the another BS so that the acquisition section overlaps the ABS, depending on the timing of the synchronization signal of the synchronization source BS or the timing of the ABS.

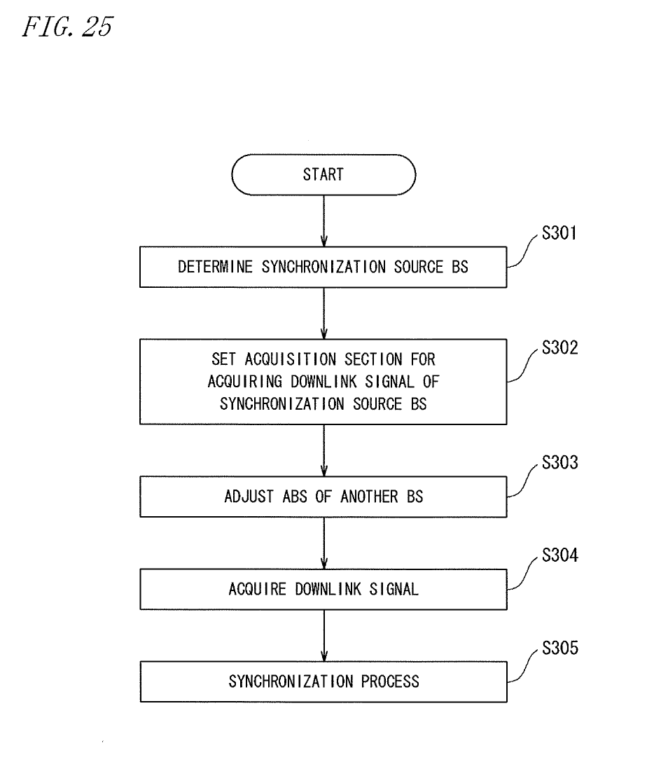

In FIG. 24, if the pico BS 1b has a compelling reason to set the acquisition section in the subframe that overlaps the ABS in the downlink signal of the macro BS 1a, the pico BS 1b performs the synchronization process as shown in FIG. 25.

FIG. 25 is a flowchart showing process steps of the synchronization process performed by the synchronization processing unit 22 of the pico BS 1b shown in FIG. 24.

The pico BS 1b determines a synchronization source BS (step S301), and sets acquisition sections (step S302). Then, the pico BS 1b transmits usable ABS pattern information to the macro BS 1a to cause the macro BS 1a to change the ABS pattern and adjust the timings of ABSs (step S303).

That is, in FIG. 24, the pico BS 1b has a reason for which it cannot move the acquisition section to a subframe different from the current subframe, and therefore, selects an ABS pattern in which the subframe in which the acquisition section is set is regarded as a subframe which cannot be used as an ABS for protection from interference from another cell, and subframes other than this subframe are determined as being protected from interference from another cell. Then, the pico BS 1b transmits, to the macro BS 1a, usable ABS pattern information based on the selected ABS pattern.

Upon receiving the usable ABS pattern information from the pico BS 1b, the macro BS 1a changes, based on the ABS pattern information, the setting of the ABS pattern such that the ABS is removed from the subframe corresponding to the timing of the acquisition section of the pico BS 1b.

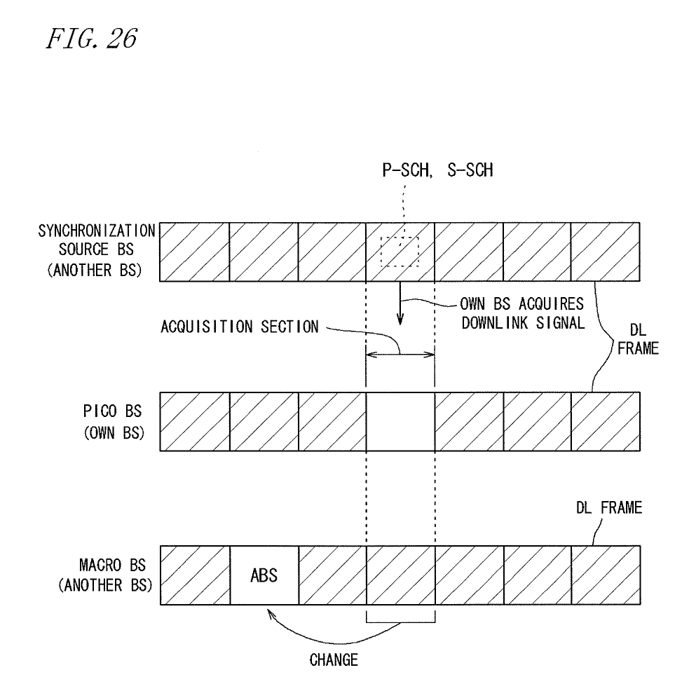

FIG. 26 is a diagram showing the state after the setting of the ABS pattern of the macro BS 1a shown in FIG. 24 has been changed.

As shown in FIG. 26, the macro BS 1a, based on the usable ABS pattern information from the pico BS 1b, changes the setting of the ABS to a subframe at a timing other than the timing of the acquisition section set by the pico BS 1b. Thereby, the acquisition section set by the pico BS 1b and the ABS set by the macro BS 1a are at different timings so that they do not overlap each other.

Thereafter, as shown in FIG. 25, the pico BS 1b, during the acquisition section, causes the transmission unit 14 to suspend transmission of its own downlink signal, and acquires the downlink signal from the synchronization source BS (step S304), thereby performing the synchronization process (step S305).

According to the pico BS 1b of the present embodiment, the communication control unit 23 notifies the macro BS 1a in which ABSs are set in its downlink signal, of the usable ABS pattern information as a notification to cause the macro BS 1a to adjust the timings of the ABSs. Therefore, even if the femto BS 1b has a reason for which it cannot move the acquisition sections set in its downlink signal, the femto BS 1b can cause the macro BS 1a to adjust the ABSs set by the macro BS 1a. Thereby, it is possible to appropriately set the relationship between the acquisition sections in which transmission of the downlink signal of the femto BS 1b needs to be suspended, and the timings of the ABSs the use of which is limited, and thus effective utilization of communication resources can be achieved.

Further, in the above-described embodiment, the communication control unit 23 notifies the macro BS 1a of the usable ABS pattern information which is set such that the pico BS 1b changes the timing of the ABS from the state in which the timing of the ABS of the macro BS 1a overlaps the timing of the acquisition section of the pico BS 1b. Therefore, it is possible to change the setting from the state where the timing of the ABS set in the downlink signal of the macro BS 1a coincides with the timing of the acquisition section as shown in FIG. 24 to the state where these timings are different from each other as shown in FIG. 26, and therefore, it is possible to reliably acquire the downlink signal of the synchronization source BS. Further, the pico BS 1b can actively utilize the ABSs set in the downlink signal of the macro BS 1a.

In the above-described embodiment, the pico BS 1b causes the macro BS 1a to adjust the ABS, based on the timing of the acquisition section set by the pico BS 1b and the timing of the ABS set by the macro BS 1a. However, in the case where the another base station device (synchronization source BS) which transmits the downlink signal to be acquired in the acquisition section is different from the another base station device (macro BS 1a) in which the blank section is set in its downlink signal as shown in FIG. 24, the usable ABS pattern information may be notified to the macro BS 1a in which the ABS is set in its downlink signal, taking into consideration the reception intensity of the downlink signal from the synchronization source BS which transmits the downlink signal to be acquired in the acquisition section.

For example, if the reception intensity of the downlink signal of the synchronization source BS, which is acquired in the acquisition section by the pico BS 1b, is relatively low, it becomes difficult for the pico BS 1b to acquire the downlink signal of the synchronization source BS in the acquisition section, due to interference by the downlink signal of the another BS than the synchronization source BS, such as the macro BS 1a. Therefore, even when the timing of the ABS and the timing of the acquisition section overlap each other, if the reception intensity of the downlink signal of the synchronization source BS is lower than a predetermined threshold, the pico BS 1b may notify the macro BS 1a in which the ABS is set, of the usable ABS pattern information that causes the macro BS 1a to maintain the timing of the ABS.

The usable ABS pattern information that causes the macro BS 1a to maintain the timing of the ABS has the content indicating the same ABS pattern as the current ABS pattern of the macro BS 1a. When the pico BS 1b transmits, to the macro BS 1a, the usable ABS pattern information which is set as described above, the macro BS 1a maintains the current ABS pattern.

In this case, if the timing of the acquisition section and the timing of the ABS are adjusted to be different from each other, there is a possibility that the downlink signal acquired in the acquisition section might be interfered because the reception intensity of the downlink signal of the synchronization source BS is smaller than the predetermined threshold. In this case, the pico BS 1b notifies the macro BS 1a of the usable ABS pattern information for causing the macro BS 1a to maintain the timing of the ABS. Thereby, in the subframe corresponding to the acquisition section of the macro BS 1a, the ABS the use of which is limited is maintained. Therefore, it is possible to prevent the downlink signal from being interfered, and it is possible to reliably acquire the downlink signal from the synchronization source BS in the acquisition section.

In the above-described third embodiment, the present invention is applied to the relationship between the pico BS 1b and the macro BS 1a. However, the present invention is applicable to the relationship between the femto BS 1c and the pico BS 1b, and to the relationship between the femto BS 1c and the macro BS 1a.

The present invention is not limited to the above-described embodiments. In the above-described embodiments, during an acquisition section set by a base station device to acquire a downlink signal from another base station device, the base station device suspends transmission of its own downlink signal. Therefore, transmission of the control signal required to maintain communication with terminal devices is also suspended, which influences the terminal devices connected to the base station device.

Therefore, the base station device notifies, in a pseudo manner, the terminal devices connected thereto that the acquisition section is a subframe for providing information by MBMS (Multimedia Broadcast Multicast Service), and thereby the influence on the terminal devices can be further reduced. The reason is as follows. Since the MBMS is a broadcast service, during the subframe used for the MBMS, minimum necessary control information indicating that the corresponding subframe is a subframe used for the MBMS is transmitted in addition to the information relating to the MBMS, by using the control channel (two symbols at the beginning of the subframe), and control information directed to a specific terminal device is not transmitted.

In the above-described embodiments, a synchronization source BS which is set as a synchronization source by a BS which sets acquisition sections is not limited to a macro BS. The synchronization source BS may be any BS such as a pico BS and a femto BS as long as its down link signal can be acquired by the BS which sets the acquisition sections.

Note that the embodiment disclosed herein is merely illustrative in all aspects and should not be recognized as being restrictive. The scope of the present invention is defined by the scope of the claims rather than by the meaning described above, and is intended to include meaning equivalent to the scope of the claims and all modifications within the scope.

Further, the reference characters used in Chapter 2 are exclusively used in Chapter 2, and are not related to the reference characters in other chapters.

### DESCRIPTION OF REFERENCE CHARACTERS

1 base station device (1a: macro base station device, 1b: pico base station device, 1c: femto base station device)
2 terminal device
20 signal processing unit
21 blank section setting unit
22 synchronization processing unit (setting unit)
23 communication control unit (notification unit)

1. A base station device comprising:
a reception unit that receives a downlink signal of another base station device;
an acquisition unit that acquires the downlink signal of the another base station device, which has been received by the reception unit; and
a setting unit that sets, in a downlink signal of the base station device, a section in which it is not necessary to transmit, to a terminal device connected to the base station device, specific information required to maintain connection between the base station device and the terminal device, wherein
the acquisition unit acquires the downlink signal from the another base station device during the section set by the setting unit.

2. The base station device according to claim 1, wherein the acquisition unit performs inter-base-station synchronization with the another base station device, based on the acquired downlink signal of the another base station device.

3. The base station device according to claim 2, wherein the acquisition unit acquires, during the section, a known signal contained in the downlink signal of the another base station device, and performs the inter-base-station synchronization based on the known signal.

4. The base station device according to claim 3, wherein the acquisition unit adjusts the positions, in the time axis direction, of the section and the downlink signal of the base station device so as to secure predetermined periods before and after the transmission timing of the known signal contained in the downlink signal of the another base station device, the periods being required for processing regarding acquisition of the downlink signal from the another base station device.

5. The base station device according to claim 3, wherein the acquisition unit adjusts the positions, in the time axis direction, of the section and the downlink signal of the base station device so that the transmission timing of the known signal contained in the downlink signal of the another base station device is located substantially in the middle of the section.

6. The base station device according to claim 1, wherein the acquisition unit performs measurement of the transmission state of the acquired downlink signal of the another base station device.

7. The base station device according to claim 1, wherein
the acquisition unit notifies the setting unit of timing information indicating the timing to acquire the downlink signal of the another base station device, and
the setting unit sets, based on the timing information, the section at the period of time during which the acquisition unit acquires the downlink signal of the another base station device.

8. The base station device according to claim 1, wherein the specific information is control information contained in each of subframes forming the downlink signal of the base station device.

9. The base station device according to claim 1, wherein the section is a section for broadcasting predetermined information to the terminal device.

10. The base station device according to claim 9, wherein the section is included in a subframe used for MBMS (Multimedia Broadcast Multicast Service).

11. The base station device according to claim 1, wherein
the setting unit previously notifies the terminal device of information indicating that the section has been set in the downlink signal of the base station device, and
the notification is performed such that, between the timing to notify the information indicating that the section has been set in the downlink signal of the base station device and the timing of the section, a time period is secured during which the terminal device can recognize that the section has been set.

12. The base station device according to claim 1, further comprising a notification unit that notifies the another base station device that a subframe including the section is a blank section for suppressing interference due to the base station device.

13. The base station device according to claim 12, wherein
when the setting unit suspends setting of the section in the downlink signal of the base station device, the notification unit notifies the another base station device that the subframe including the section to be suspended is not a blank section for suppressing interference due to the base station device, before use of the subframe including the section to be suspended is started.

14. A base station device comprising:
A setting unit that sets, in a downlink signal of the base station device, an acquisition section for acquiring a downlink signal of another base station device, wherein
The setting unit sets the acquisition section, based on the timing of a blank section for suppressing interference due to the base station device, the blank section being set in the downlink signal of the base station device or the downlink signal of the another base station device.

15. The base station device according to claim 14, wherein the setting unit sets the acquisition section in the blank section set in the downlink signal of the base station device.

16. The base station device according to claim 14, wherein the setting unit sets the acquisition section at a timing different from the timing of the blank section set in the downlink signal of the another base station device.

17. A base station device comprising:
a setting unit that sets, in a downlink signal of the base station device, an acquisition section for acquiring a downlink signal of another base station device; and
a notification unit that transmits, to the another base station device in which a blank section is set in its downlink signal, a notification that causes the another base station device to adjust the timing of the blank section, based on the timing of the acquisition section set by the setting unit, and on the timing of the blank section for suppressing interference due to the base station device, which is set in the downlink signal of the another base station device.

18. The base station device according to claim 17, wherein
when the timing of the blank section and the timing of the acquisition section overlap each other, the notification unit transmits, to the another base station device in which the blank section is set in its downlink signal, a notification that causes the another base station device to change the timing of the blank section.

19. The base station device according to claim 17, wherein
when the another base station device that transmits the downlink signal to be acquired in the acquisition section is different from the another base station device in which the blank section is set in its downlink signal, the notification unit transmits, to the another base station device in which the blank section is set in its downlink signal, a notification that causes the another base station device in which the blank section is set in its downlink signal to adjust the timing of the blank section, taking into consideration the reception intensity of the downlink signal of the another base station device that transmits the downlink signal to be acquired in the acquisition section.

20. The base station device according to claim 19, wherein
when the timing of the blank section and the timing of the acquisition section overlap each other and the reception intensity is lower than a predetermined threshold, the notification unit transmits, to the another base station device in which the blank section is set in its downlink signal, a notification that causes the another base station device to maintain the timing of the blank section.
